(19) United States
(12) Patent Application Publication
(10) Pub. No.: US 2016/0364178 A1
(43) Pub. Date: Dec. 15, 2016

(54) INFORMATION PROCESSING APPARATUS, INFORMATION PROCESSING SYSTEM, STORAGE MEDIUM AND INFORMATION PROCESSING METHOD

(71) Applicant: NINTENDO CO., LTD., Kyoto (JP)

(72) Inventors: Toshiharu IZUNO, Kyoto (JP); Akira OTANI, Kyoto (JP); Satoshi KIRA, Kyoto (JP); Shunsuke KOBAYASHI, Tokyo (JP); Jun IWASAKI, Tokyo (JP)

(21) Appl. No.: 14/839,312

(22) Filed: Aug. 28, 2015

(30) Foreign Application Priority Data
Jun. 12, 2015 (JP) 2015-119026

(51) Int. Cl. G06F 3/06; H04W 4/00

(52) U.S. Cl. CPC G06F 3/0659; G06F 3/0604; G06F 3/0683; H04W 4/008

(57) ABSTRACT

A non-limiting example game apparatus includes a CPU, and the CPU performs a non-contact communication with an IC tag that is incorporated in a figure by using a non-contact communication module. When card information data is read from each of two figures (EEPROM incorporated in the IC tag) and the same card object is set usable, for example, the card object concerned is changed to a special card object. That is, a special card object is produced.

### CROSS REFERENCE OF RELATED APPLICATION

The disclosure of the patent application No. 2015-119026 filed on Jun. 12, 2015 is incorporated by reference.

### FIELD

This application describes an information processing apparatus, an information processing system, a storage medium and an information processing method, performing a non-contact communication with a storage medium.

### SUMMARY

It is a primary object of an embodiment(s) to provide a novel information processing apparatus, information processing system, storage medium and information processing method.

It is another object of the embodiment(s) to provide an information processing apparatus, information processing system, storage medium and information processing method, capable of improving amusement in information processing that performs a non-contact communication with storage medium.

A first embodiment is an information processing apparatus, comprising: a communication module, a reading module, an object producing module, and a writing module. The communication module is configured to perform a non-contact communication with each of a first storage medium and a second storage medium. The reading module is configured to read first data from the first storage medium and read second data from the second storage medium while using the communication module. The object producing module is configured to produce a first object by using the first data and the second data that are read by the reading module. The first object is produced by directly using at least one of the first data and the second data, for example. The writing module is configured to write the first object that is produced by the object producing module in at least one of the first storage medium and the second storage medium while using the communication module.

According to the first embodiment, since an object is produced by reading data from two storage media, it is possible to increase pleasure to produce the object and pleasure to increase the number of objects. Furthermore, it is possible to obtain a sense of accomplishment by increasing the number of objects. Therefore, it is possible to improve amusement in information processing that performs a non-contact communication with a storage medium.

A second embodiment is according to the first embodiment, wherein the object producing module is configured to further produce a second object that differs from the first object by using the first data or the second data.

According to the second embodiment, since the second object different from the first object is further produced, it is possible to increase more the pleasure to produce an object.

A third embodiment is according to the second embodiment, wherein the first object and the second object are different in ability from each other. For example, the second object is higher or lower than the first object in ability.

In the third embodiment, it is also possible to increase the pleasure to produce an object like the second embodiment.

A fourth embodiment is according to the first embodiment, and further comprises a decision module. The decision module is configured to decide, when the first data is read from the first storage medium or the second data is read from the second storage medium by the reading module, by a predetermined method whether the second data can be succeedingly read from the second storage medium or the first data can be succeedingly read from the first storage medium. Therefore, there is an occasion that both the first data and the second data cannot be necessarily acquired. When it is decided by the decision module that it is possible to read the second data from the second storage medium or the first data from the first storage medium, the reading module reads the second data from the second storage medium or the first data from the first storage medium.

According to the fourth embodiment, since there is an occasion that both the first data and the second data cannot be necessarily acquired, an object that is produced can be changed depend on the occasion.

A fifth embodiment is according to the fourth embodiment, and further comprises a notifying module. The notifying module is configured to notify the second storage medium or the first storage medium that is reading candidate when it is decided by the decision module that the second data can be read from the second storage medium or the first data can be read from the first storage medium.

According to the fifth embodiment, since the reading candidate is notified when data can be read from the second storage medium or the first storage medium in subsequent to the first storage medium or the second storage medium, it is possible to easily know a storage medium that is made to perform communication with the communication module.

A sixth embodiment is according to the first embodiment, and further comprises a first determination module. The first determination module is configured to determine whether the first data read from the first storage medium and the second data read from the second storage medium satisfy a predetermined condition. The object producing module produces the first object by using the first data and the second data when it is determined by the first determination module that the predetermined condition is satisfied.

According to the sixth embodiment, since an object is produced using two storage media and the data respectively stored therein, it is possible to increase more the pleasure to produce an object.

A seventh embodiment is according to the first embodiment, and further comprises a second determination module. The second determination module is configured to determine whether the first object or the second object stored in the first storage medium and the first object or the second object stored in the second storage medium satisfy a predetermined condition.

The object producing module produces a third object combining the first objects with each other or a fourth object combining the second objects with each other when it is determined that the first object or the second object stored in the first storage medium and the first object or the second object stored in the second storage medium satisfy the predetermined condition.

According to the seventh embodiment, since by using the two storage media an object that is different from the objects respectively stored therein, it is possible to increase more the pleasure to produce an object.

An eighth embodiment is according to the seventh embodiment, wherein the second determination module is executable within a predetermined restriction.

According to the eighth embodiment, since the predetermined restriction is provided, an object that is different from the objects respectively stored in the two storage media is increased gradually in the number, it is possible to increase more pleasure to produce the object and pleasure to increase the number of objects.

A ninth embodiment is according to the first embodiment, and further comprises an execution module. The execution module is configured to execute an application. The first object and the second object can be used in a predetermined scene of the application.

According to the ninth embodiment, since the produced object can be used in the predetermined scene of the application, the pleasure to produce an object can be increased more. Furthermore, when the object affects advance of the application, it is possible to give a user motivation to increase the number of the objects. Therefore, it is possible to improve amusement in information processing that performs a non-contact communication with a storage medium.

A tenth embodiment is an information processing system, comprising: a communication module configured to perform a non-contact communication with each of a first storage medium and a second storage medium; a reading module configured to read first data from the first storage medium and read second data from the second storage medium while using the communication module; an object producing module configured to produce an object by using the first data and the second data that are read by the reading module; and a writing module configured to write the object that is produced by the object producing module in at least one of the first storage medium and the second storage medium while using the communication module.

An eleventh embodiment is a non-transitory storage medium storing an information processing program executable by a computer comprising a communication module configured to perform a non-contact communication with each of a first memory and a second memory, wherein the information processing program causes the computer to function as: a reading module configured to read first data from the first memory and read second data from the second memory while using the communication module; an object producing module configured to produce an object using the first data and the second data that are read by the reading module; and a writing module configured to write the object that is produced by the object producing module in at least one of the first memory and the second memory while using the communication module.

A twelfth embodiment is an information processing method that is executed by a computer comprising a communication module configured to perform a non-contact communication with each of a first storage medium and a second storage medium, wherein the information processing method comprising steps of: (a) reading first data from the first storage medium and read second data from the second storage medium while using the communication module; (b) producing an object using the first data and the second data that are read in the step (a); and (c) writing the object that is produced in the step (b) in at least one of the first storage medium and the second storage medium while using the communication module.

According to the tenth to twelfth embodiments, it is also possible to improve amusement in information processing that performs a non-contact communication with a storage medium, like the first embodiment.

The above described objects and other objects, features, aspects and advantages of the embodiments will become more apparent from the following detailed description when taken in conjunction with the accompanying drawings.

### BRIEF DESCRIPTION OF THE DRAWINGS

FIG. 1 is a block diagram showing non-limiting example electric structure of a game apparatus.

FIGS. 2(A)-2(C) show non-limiting example appearances of figures that perform a non-contact communication with a game apparatus shown in FIG. 1, wherein FIG. 2(A) is an illustration view showing an example of an appearance of a figure about a first game character, FIG. 2(B) is an illustration view showing an example of an appearance of a figure about a second game character, and FIG. 2(C) is an illustration view showing an example of an appearance of a figure about a third game character.

FIG. 3 is a block diagram showing non-limiting example electric structure of an IC tag incorporated in the figure shown in FIGS. 2(A)-2(C).

FIG. 4(A) is an illustration view showing a non-limiting example main menu screen displayed on a display of FIG. 1, and FIG. 4(B) is an illustration view showing a non-limiting example battle screen displayed on the display of FIG. 1.

FIG. 5(A) is an illustration view showing a non-limiting example placement screen displayed on the display of FIG. 1, and FIG. 5(B) is an illustration view showing a non-limiting example use card selection screen displayed on the display of FIG. 1.

FIG. 6(A) is an illustration view showing a non-limiting example card production menu screen displayed on the display of FIG. 1, and FIG. 6(B) is an illustration view showing a non-limiting example production origin card selection screen.

FIG. 7(A) is an illustration view showing a non-limiting example screen under single card production displayed on the display of FIG. 1, and FIG. 7(B) is a non-limiting example screen after single card production displayed on the display of FIG. 1.

FIG. 8(A) is an illustration view showing a non-limiting example screen under pair card production displayed on the display of FIG. 1, and FIG. 8(B) is a non-limiting example screen after pair card production displayed on the display of FIG. 1.

FIG. 9(A) is an illustration view showing a non-limiting example possession card screen displayed on the display of FIG. 1, and FIG. 9(B) is an illustration view showing a non-limiting example special card selection screen displayed on the display of FIG. 1.

FIG. 10 is a flowchart showing non-limiting example entire processing of a CPU shown in FIG. 1.

FIG. 11 is a flowchart showing non-limiting example battle game processing of the CPU shown in FIG. 1.

FIG. 12 is a flowchart showing a part of non-limiting example figure use processing of the CPU shown in FIG. 1.

FIG. 13 shows the other part of the non-limiting example figure use processing of the CPU shown in FIG. 1, following FIG. 12.

FIG. 14 is a flowchart showing a part of non-limiting example normal card production processing of the CPU shown in FIG. 1.

FIG. 15 is a flowchart showing another part of the non-limiting example normal card production processing of the CPU shown in FIG. 1, following FIG. 14.

FIG. 16 is a flowchart showing the other part of the non-limiting example normal card production processing of the CPU shown in FIG. 1, following FIG. 15.

FIG. 17 is a flowchart showing non-limiting example pair card production processing of the CPU shown in FIG. 1.

FIG. 18 is a flowchart showing a part of non-limiting example special card production processing of the CPU shown in FIG. 1.

FIG. 19 shows another part of the non-limiting example special card production processing of the CPU shown in FIG. 1, following FIG. 18.

FIG. 20 shows a further part of the non-limiting example special card production processing of the CPU shown in FIG. 1, following FIG. 19.

FIG. 21 shows the other part of the non-limiting example special card production processing of the CPU shown in FIG. 1, following FIG. 20.

### DETAILED DESCRIPTION OF NON-LIMITING EXAMPLE EMBODIMENTS

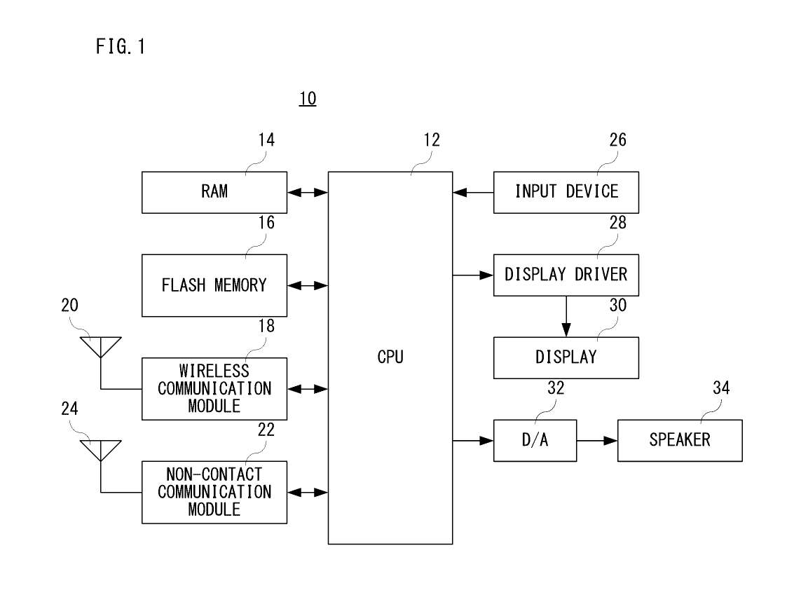

With reference to FIG. 1, a non-limiting example game apparatus 10 that is an example of an information processing apparatus includes a CPU 12 that is connected with a RAM14, a flash memory 16, a wireless communication module 18, a non-contact communication module 22, an input device 26, a display driver 28 and a D/A converter 32. Furthermore, an antenna 20 is connected to the wireless communication module 18, and an antenna 24 is connected to the non-contact communication module 22. Furthermore, a display 30 is connected to the display driver 28, and a speaker 34 is connected to the D/A converter 32.

The CPU 12 takes charge of entire control of the game apparatus 10. The RAM14 is used as a working memory and a buffer memory of the CPU 12. The flash memory 16 is used in order to store an application program (information processing program) such as game application and to store (save) various kinds of data. However, there is no necessity that application is limited to a game application, various kinds of application such as a document production application, an email application, a painting application, character or letter practice application, a linguistic training application, a study application, etc. corresponds.

The wireless communication module 18 has a function linked to a wireless LAN. Therefore, the game apparatus 10 can communicate with a computer and other game apparatuses 10 directly or via a network.

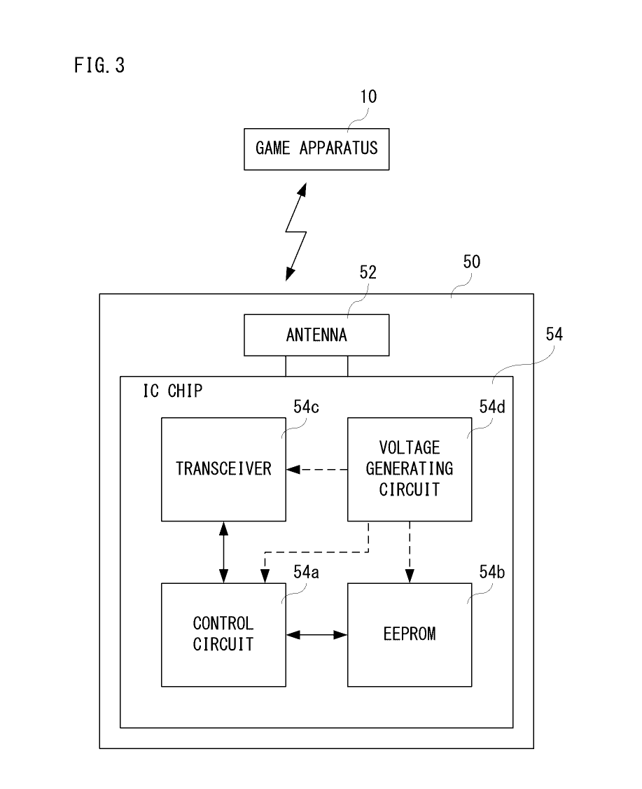

The non-contact communication module 22 performs non-contact data communication with radio between an IC tag 50 (see FIG. 3) according to the telecommunications standard of ISO/IEC18092 (so called NFC), etc., for example. A communication distance is few or several centimeters to few or several meters. The non-contact communication module 22 transmits to the IC tag 50 a signal (read instruction) that instructs read-out of data being stored, and receives desired data as a response to this. That is, the non-contact communication module 22 functions as a reader of the IC tag 50. Furthermore, the non-contact communication module 22 can make the IC tag 50 perform writing of data by transmitting a signal (write instruction) that instructs write-in together with the data to be written. That is, the non-contact communication module 22 functions as a writer of the IC tag 50.

In addition, although the non-contact communication module 22 transmits and receives data to or from the IC tags 50 according to the telecommunication standard of NFC in this embodiment, does not need to be limited to this. In other embodiments, a communication method of the non-contact communication module 22 may be various communication methods adopted as a non-contact communication or a short-distance wireless communication.

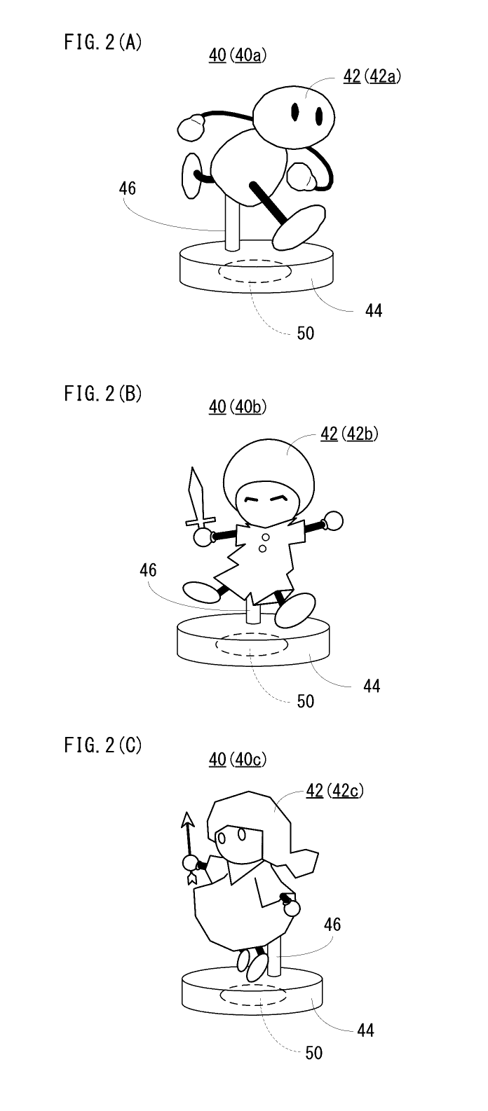

As shown in FIG. 2(A), FIG. 2(B) and FIG. 2(C), a predetermined FIG. 40 includes a figure main body 42 imitating a game character, a base 44 and a fixing member 46 for fixing the figure main body 42 to the base 44. However, when the figure main body 42 can be fixed to the base 44 with intensity of a certain degree, the fixing member 46 is omitted. Furthermore, as an example, a label sheet type IC tag 50 is used, and this IC tag 50 is fixed (adhered) to an inside of the base 44. However, a coin type one may be used as the IC tag 50.

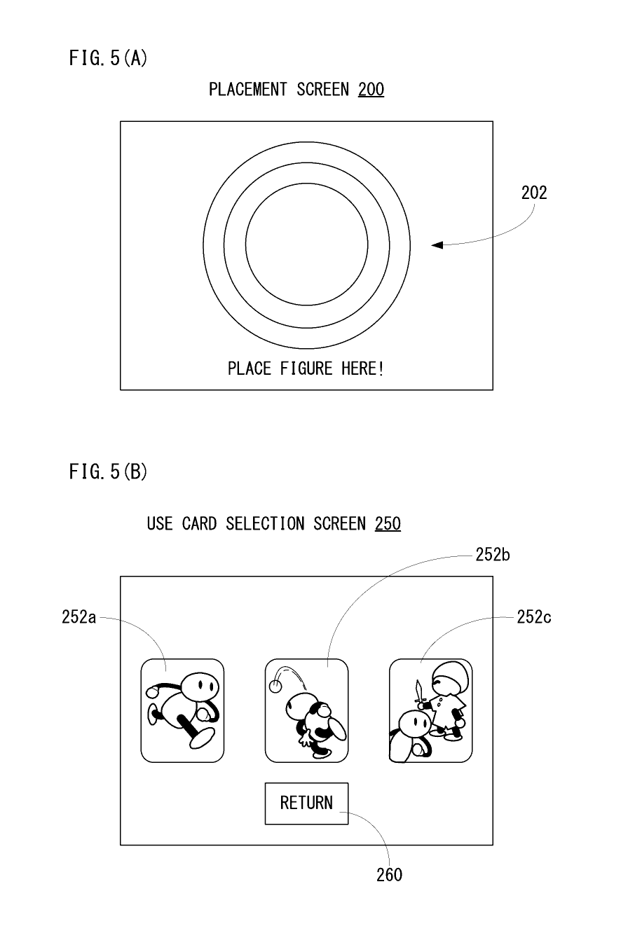

In the examples shown in FIG. 2(A)-FIG. 2(C), the figure main body 42 is formed so as to imitate a protagonist character (player character 152) of the game describe later. As shown also in FIG. 2(A)-FIG. 2(C), two or more kinds of game characters that can turn into a protagonist character exist, and a user or player (hereinafter, simply called “player”) selects any one kind of game character as the protagonist character at a time of a game start. Other game characters that the player does not select as a protagonist character are selected as a game character (friend character 154) of a friend of the protagonist character, and can participate (appear) in the game (see FIG. 5(A)).

In addition, although three kinds of game characters that can turn into a protagonist character are shown here, the kind (number) does not need to be limited, and in this embodiment, it may be four or more kinds as long as two or more kinds. Furthermore, as shown in FIG. 2(A)-FIG. 2(C), the kinds of the game characters are different from each other in three FIGS. 40 (40a, 40b, 40c). For example, the FIG. 40a includes a figure main body 42a imitating a first game character, the FIG. 40b includes a figure main body 42b imitating a second game character, and the FIG. 40c includes a figure main body 42c imitating a third game character.

In the following, when it is necessary to describe the FIGS. 40a, 40b and 40c to be identifiable, these are described with using identifiable reference characters, but when it is not necessary to describe to be identifiable, these may be simply called the “figure 40.” This is also the same about the figure main bodies 42a, 42b and 42c.

Returning to FIG. 1, the input device 26 includes various kinds of operating buttons or/and a touch panel. Therefore, if the player operates an operating button or/and the touch panel, corresponding operation data or/and touch coordinate data is input into the CPU 12. Hereinafter, the operation data or/and the touch coordinate data may be called “operation input data”.

The display driver 28 is used in order to display various kinds of screens on the display 30 under instructions of the CPU 12. In addition, the CPU 12 uses a part of the RAM 14 as a video RAM (VRAM) so as to produce image data corresponding to various kinds of screens.

The D/A converter 32 converts sound data applied from the CPU 12 into an analog sound signal, and outputs the same to the speaker 34. In addition, the sound signal is a sound signal corresponding to a sound effect and music (BGM) when the application is executed. When a game application is executed, for example, a sound signal corresponding to an imitation sound that a character or object utters or generates may be output.

In addition, the electric structure of the game apparatus 10 shown in FIG. 1 is a mere example, and does not need to be limited to this.

FIG. 3 is a block diagram showing an example of electric structure of the IC tag 50 incorporated in the base 44 of the FIG. 40 of FIGS. 2(A)-2(C). The IC tag 50 is a general-purpose passive type RFID tag, and includes an antenna 52 wound in a shape of a coil, and an IC chip 54 is connected to this antenna 52. The IC chip 54 comprises a control circuit 54a, an EEPROM 54b, a transceiver circuit 54c and a voltage generating circuit 54d. In addition, instead of the EEPROM 54b, other nonvolatile memories such as a flash memory may be provided.

The IC tag 50 receives by the antenna 52 a radio wave including a wireless signal from a reader/writer (the non-contact communication module 22 in this embodiment), and when receiving the radio wave, the voltage generating circuit 54d rectifies the received radio wave, and generates (produces) a power supply voltage required for the control circuit 54a, the EEPROM 54b and the transceiver circuit 54c, and supplies the power supply voltage. In FIG. 3, a power supply line that supplies the power supply voltage is shown by a dotted line.

The transceiver circuit 54c demodulates instructions or/and data from the received radio wave to apply to the control circuit 54a. The control circuit 54a receives the demodulated instructions or/and data, and executes processing according to the instructions. If it is a data write instruction, for example, the control circuit 54a writes the data that is received together with the write instruction concerned in the EEPROM 54b.

Furthermore, if the demodulated instruction is a data read instruction, the control circuit 54a reads data from the EEPROM 54b according to the read instruction concerned, and applies the read data to the transceiver circuit 54c. Then, the transceiver circuit 54c modulates the data and transmits from the antenna 52 by a carrier wave. Therefore, the game apparatus 10 receives the radio wave that is transmitted from the IC tag 50 by the non-contact communication module 22 via the antenna 24.

For example, the EEPROM 54b is stored with data of identification information (figure ID) about the FIG. 40 that incorporates this IC tag 50 and predetermined game data about a game application that uses the FIG. 40 concerned. Furthermore, when the FIG. 40 is registered corresponding to the game apparatus 10 that the game application of this embodiment is executed, data of identification information (game machine ID) about the game apparatus 10 concerned is also stored. That is, if the game machine ID is stored in the EEPROM 54b that is incorporated in the IC tag 50, the game apparatus 10 and the FIG. 40 incorporating this IC tag 50 are associated with each other.

Here, the figure ID includes information for identifying the kind of the FIG. 40 (kind information), information for identifying the FIG. 40 individually in such the kind (individual information) and information for identifying the game application that the FIG. 40 is used (game information). In addition, the kind information is information for identifying kinds of the character (the first game character, the second game character and the third game character) of the FIG. 40 (figure main body 42). Furthermore, since two or more the same kind (game character) of FIG. 40 exist, for example, the individual information is assigned in order to make identifiable the FIG. 40 that are physically different (separate) from each other but of the same kind.

The predetermined game data is, in this embodiment, data (card information data) about an item (card object in this embodiment) obtained (created or produced) by executing the game application that uses the FIG. 40 concerned. The number (the maximum number) and kind of card objects that the game character can possess are defined in advance, and the card information data includes information about whether each card object is usable (possession) or unusable (non-possession). However, a virtual game is a game that can be played when the game application using the FIG. 40 is executed.

The game machine ID is inherent identification information assigned to the game apparatus 10, and it is assigned in a manufacture process, or the MAC Address etc. assigned to the wireless communication module 18 is used as that.

Next, a virtual game that can be played in such the game apparatus 10 when a game application (game program) of this embodiment is executed will be described. In this game application, a game (battle game) that fights against an enemy character can be played. Furthermore, in this game application, it is possible to produce a predetermined item (a virtual card object in this embodiment) using a virtual production origin card object obtained by playing the battle game etc. However, the card object is prepared in a predetermined number as described above, and if a card object is produced using the production origin card object, the card object concerned is set to usable. In addition, the production origin card object is an object that becomes a source or origin of a card object. Furthermore, in this game application, the card object that the game character such as a player character possesses can be changed to a particular or special card object (special card object). That is, it is possible to produce a special card object.

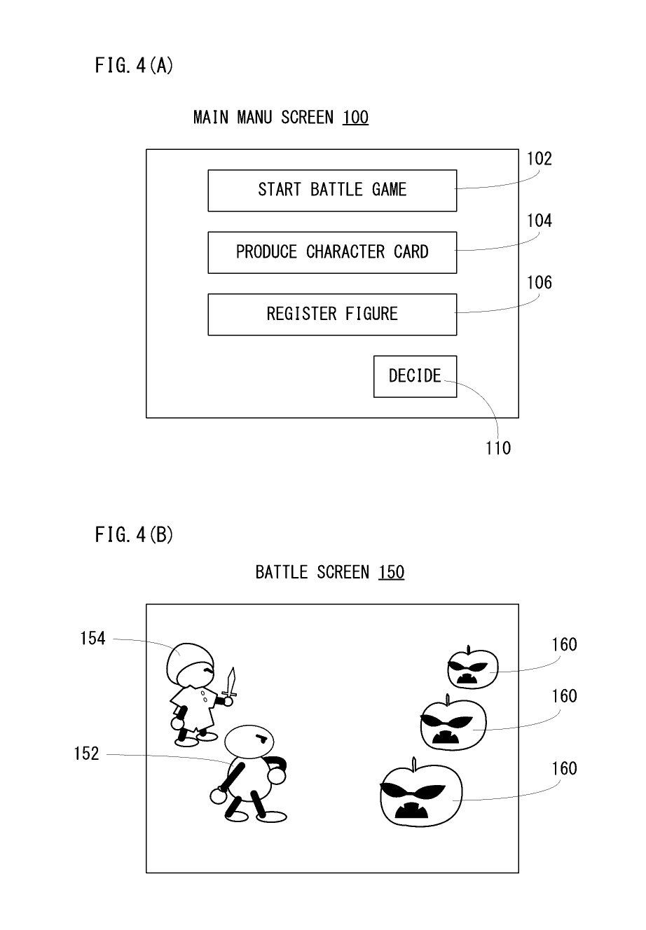

Here, a card object is an item that can be used in a battle game, and a predetermined effect can be activated by using this. If the predetermined effect is activated, an ability value (offensive power, defensive power, numerical value or level such as quickness) of the player character 152 or/and the friend character 154 described later may be made high, and/or a physical strength value or damage of the player character 152 or/and the friend character 154 may be recovered (see FIG. 4(B)).

Furthermore, the special card object is set to be larger than the normal card object in an effect that is activated by them. In the following, a card object other than a special card object may be called a normal card object. However, when there is no necessity of distinguishing the normal card object and the special card object from each other, simply called a “card object”. Furthermore, as describe later, the normal card object is prepared with two kinds such as a single card object and a pair card object, when roughly divided. Therefore, when there is necessity of distinguishing these, the normal card object may be called a single card object or a pair card object.

If the application is executed, a main menu screen 100 as shown in FIG. 4(A) is displayed on the display 30. An icon 102, an icon 104 and an icon 106 are displayed on the main menu screen 100. The icon 102 is provided in order to play (start) a battle game. The icon 104 is provided in order to produce a card object. The icon 106 is provided in order to register into the game apparatus 10 the FIG. 40 that a player owns as the FIG. 40 that is used in this game application.

FIG. 4(B) shows an example of a game screen (battle screen) 150 displayed on the display 30 when playing a battle game. The player character 152, the friend character 154 and a plurality of enemy characters 160 are displayed on the battle screen 150. As shown also in FIG. 4(B), a group (party) of the player character 152 and the friend character 154 is displayed on the battle screen 150 so as to confront a group of the plurality of enemy characters 160.

For example, if the player performs an operation to use the FIG. 40 in an attack turn of the player, as shown in FIG. 5(A), a placement screen 200 for placing the FIG. 40 onto (passing over) the game apparatus 10 is displayed on the display 30. This placement screen 200 is displayed in parallel to the battle screen 150, for example. However, instead of the battle screen 150, the placement screen 200 may be displayed on the display 30. In the following, this is the same about a case where the placement screen 200 is displayed.

As shown in FIG. 5(A), a designating image 202 for designating to the player a position that the FIG. 40 is to be placed is displayed on the placement screen 200, and below it, a message that the FIG. 40 should be placed on the placement screen 200 is displayed.

If the player place the FIG. 40 on the placement screen 200 (display surface of the display 30), the game apparatus 10 acquires the figure ID and the game machine ID from the FIG. 40 (IC tag 50). If the FIG. 40 is of the kind usable in the game application concerned and registered in the game apparatus 10 as the FIG. 40 that is used in the game application concerned, the game apparatus 10 acquires card information data from this FIG. 40. That is, when the game information included in the figure ID that is acquired from the FIG. 40 shows this game application and the game machine ID of the game apparatus 10 is registered into this FIG. 40, card information data is acquired from this FIG. 40.

However, if the FIG. 40 is not of the kind usable in the game application concerned, it is notified that a figure other than a predetermined kind (FIG. 40 usable in the game application of this embodiment) is unusable, and it is waited for a FIG. 40 of the kind usable in the game application concerned is placed on the placement screen 200.

Furthermore, when the FIG. 40 is of the kind usable in the game application concerned but not registered in the game apparatus 10 as the FIG. 40 usable in the game application concerned, it is notified that the FIG. 40 cannot be used if not registered, and processing that a card object is used using the FIG. 40 is terminated, and returns to the battle game.

The game apparatus 10 displays a use card selection screen 250 as shown in FIG. 5(B) on the display 30 if the card information data is acquired from the FIG. 40. This use card selection screen 250 is displayed instead of the placement screen 200, and displayed in parallel with the battle screen 150, for example.

Card objects 252a, 252b and 252c are displayed on this use card selection screen 250. Furthermore, an icon 260 is displayed below the card object 252b. The card objects 252a-252c are card objects being set usable in the card information data.

If the player selects a desired card object out of the card objects being usable, a predetermined effect assigned to the card object is activated.

In an example shown in FIG. 5(B), the card object 252a and the card object 252b are single card objects, and an image of a single game character is displayed as a pattern. Here, images having poses different from each other of the player character 152 are displayed on the card object 252a and the card object 252b as a pattern. Furthermore, the card object 252c is the pair card object, and an image of pair game characters is displayed as a pattern. Here, the image of the player character 152 and the friend character 154 is displayed on the card object 252c as a pattern.

For example, when the card object 252a is selected, only the quickness of the player character 152 is increased by a predetermined rate. Furthermore, when the card object 252b is selected, an offensive power of the player character 152 is increased by a first predetermined rate. Furthermore, when the card object 252c is selected, an offensive power of the player character 152 is increased by a second predetermined rate higher than the first predetermined rate.

That is, if a single card object is used, the ability value of the player character 152 is increased, or a physical strength value is recovered. Furthermore, if a pair card object is used, in comparison with a case where the single card object is used, the ability value of the player character 152 is increased more largely, or the physical strength value is recovered more largely. In addition, when the pair card object is used, the effect may be activated also about the friend character displayed as a pattern of the pair card object concerned.

Furthermore, the icon 260 is provided in order to return to the battle game without selecting a card object.

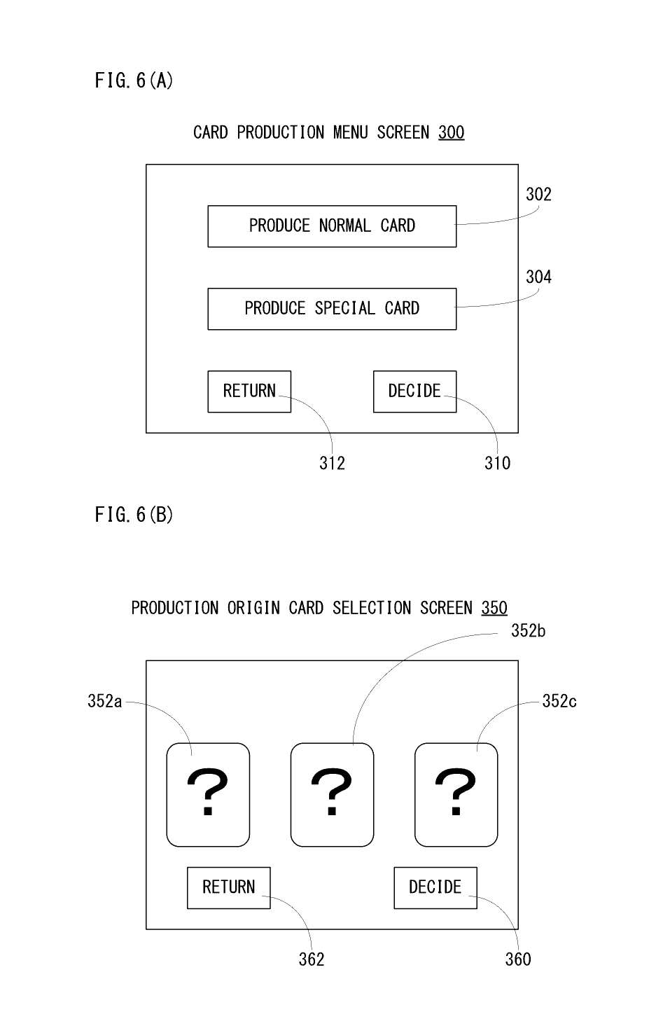

Furthermore, if the icon 104 is selected in the main menu screen 100 shown in FIG. 4(A), producing a card object is selected. Then, a card production menu screen 300 as shown in FIG. 6(A) is displayed on the display 30.

In the card production menu screen 300, an icon 302 and an icon 304 are displayed, and an icon 310 and an icon 312 are further displayed below the icon 304.

The icon 302 is used in order to select production of a normal card object. Furthermore, the icon 304 is used in order to select production of a special card object.

The icon 310 is used in order to execute (start) processing selected by the icon 302 or the icon 304. The icon 312 it is used in order to return to a main menu while stopping production of a card object. Therefore, if the icon 312 is selected, instead of the card production menu screen 300, the main menu screen 100 is displayed on the display 30. Hereinafter, this is the same about a case of returning to the main menu.

If the icon 310 is selected in a state where the icon 302 is selected in the card production menu screen 300 shown in FIG. 6(A), production processing of a normal card object is executed. If starting the production processing of a normal card object, a production origin card selection screen 350 as shown in FIG. 6(B) is displayed on the display 30.

Production origin card objects 352a, 352b and 352c are displayed in the production origin card selection screen 350. Furthermore, below the production origin card object 352c, an icon 360 is displayed, and an icon 362 is displayed below the production origin card object 352a.

The production origin card objects 352a-352c are card objects that becomes a source or origin of a normal card object obtained in the battle game etc. Information on this production origin card object is included in main body game data.

Furthermore, the icon 360 is provided in order to instruct production of a normal card object. The icon 362 is provided in order to stop the production of a normal card object, and returns to a main menu.

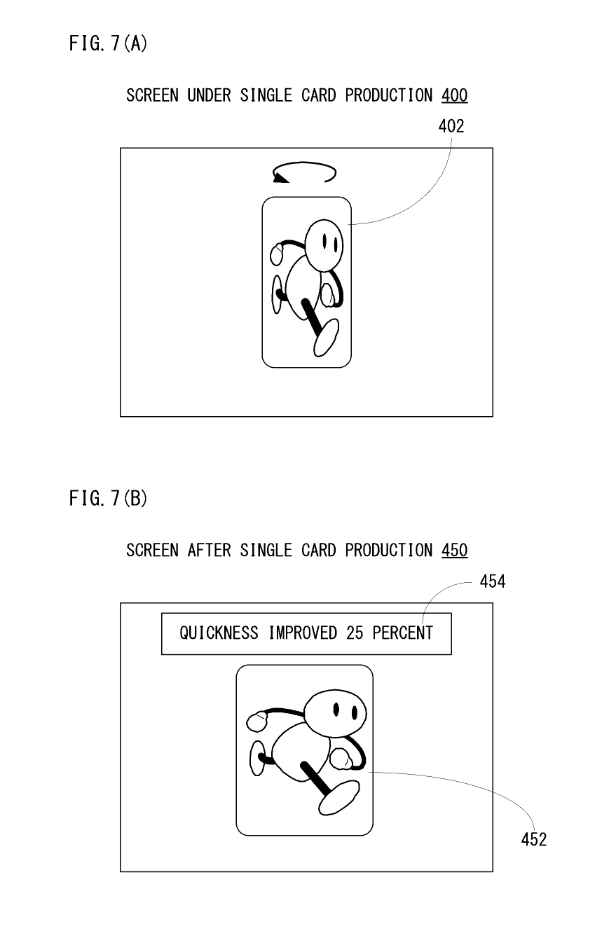

As described above, if the icon 310 is selected, the production processing of a normal card object is executed (started), and instead of the production origin card selection screen 350, a screen under single card production 400 is displayed on the display 30 as shown in FIG. 7(A). On this screen under single card production 400, a card object 402 under production is displayed while being rotated. Although cannot be expressed in the drawing, patterns of a plurality of single card objects that are producible (currently unusable) are sequentially displayed on the card object 402 under production at a predetermined time interval (0.5 second-1 second, for example). However, when the number of the single card objects that are producible is one, a pattern of the single card object concerned is continuously displayed.

In addition, an arrow mark on the card object 402 under production only shows a manner that the card object 402 concerned is rotating, and is not displayed in fact. This is the same about a screen under pair card production 500 describe later.

Furthermore, if the screen under single card production 400 is displayed on the display 30, and in parallel with this, the placement screen 200 as shown in FIG. 5(A) is displayed on the display 30.

If the player places the FIG. 40 on the placement screen 200 (display surface of the display 30), the game apparatus 10 acquires a figure ID and a game machine ID from the FIG. 40 (IC tag 50). If the FIG. 40 is of the kind usable in the game application concerned and is registered in the game apparatus 10 as what is used in the game application concerned, the game apparatus 10 acquires card information data from this FIG. 40. Then, the production of a normal card object (single card object) is continued. In this embodiment, the FIG. 40 that is placed on the placement screen 200 here is the FIG. 40 corresponding to the player character 152.

However, if the FIG. 40 is not of the kind usable in the game application concerned, it is notified that a figure other than a predetermined kind (FIG. 40 usable in the game application of this embodiment) cannot be used, and it is waited for that the FIG. 40 of the kind usable in the game application concerned is placed on the placement screen 200.

Furthermore, when the FIG. 40 is of the kind usable in the game application concerned but not registered in the game apparatus 10 as the FIG. 40 used in the game application concerned, it is notified that the FIG. 40 cannot be used if not registered, and the processing producing a normal card object using the FIG. 40 is terminated, and returns to a main menu.

A single card object to be produced is selected from one or more single card objects in an unusable state by a computer lottery. For example, probability of the lottery is set for each of a plurality of single card objects. In addition, it is possible to know the single card object in the unusable state by referring to the card information data acquired from the FIG. 40.

In addition, the single card object to be produced may be determined (selected) at random not dependent on the lottery.

If one single card object is produced, that is, if one single card object selected by the lottery is set usable, instead of the screen under single card production 400, a screen after single card production 450 as shown in FIG. 7(B) is displayed on the display 30.

One single card object 452 that is produced is displayed on the screen after single card production 450, and a display area 454 is provided above it. An image of the player character 152 of a predetermined pose is displayed on the single card object 452 as a pattern. Furthermore, contents of the effect activated by using the produced single card object 452 is displayed with a text in the display area 454. Here, description that the quickness is increased 25 percent (%) is indicated (displayed).

If one single card object 452 is produced, after card information data is updated and the updated card information data is written in the FIG. 40, the screen returns to the production origin card selection screen 350 shown in FIG. 6(B), and the normal card production processing is continued. If the single card object 452 is produced, the card information data is updated such that the information of the single card object 452 concerned in the card information data is set usable. When a pair card object is produced, as described later, the card information data is updated similarly.

However, when the card information data is to be written, the placement screen 200 as shown in FIG. 5(A) is displayed, and after confirming (authenticating) whether the FIG. 40 is the same as the FIG. 40 that the card information data is acquired at the time of production of a normal card object, the updated card information data is written. At this time, the figure ID is read in from the FIG. 40, and it is determined that the individual information included in the read figure ID corresponds to the individual information included in the figure ID that is acquired at the time of production start of the normal card object.

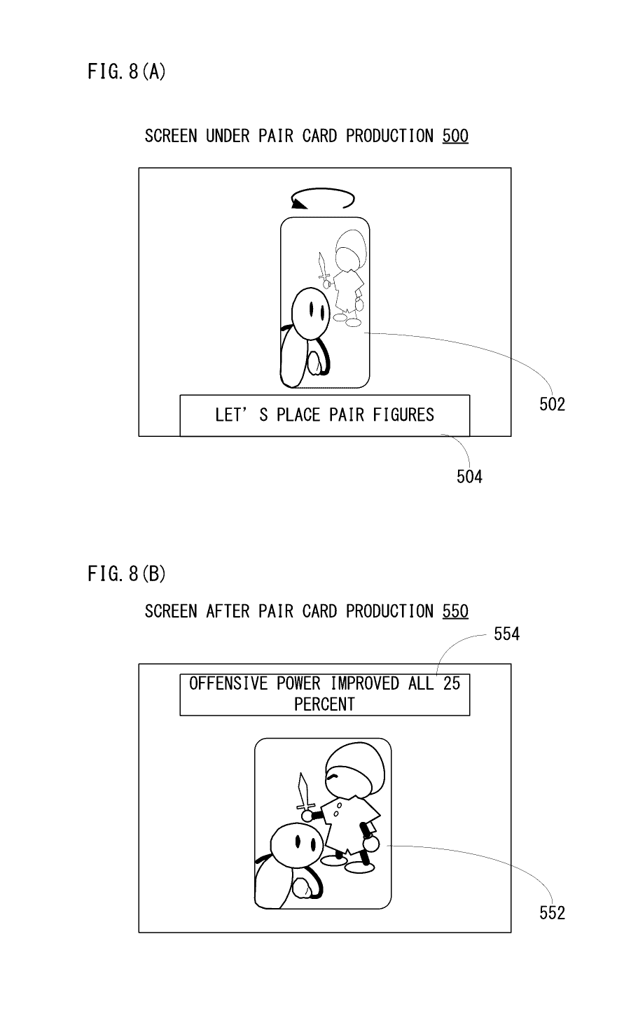

Furthermore, if the production processing of the normal card is started, in parallel to display processing of the screen under single card production 400 described above, a opportunity of a pair card object production is given by the lottery. Specifically, prior to the lottery of the single card object, it is drawn lots by a computer (CPU 12) whether the opportunity of the pair card object production is given. The probability of this lottery is set in advance for each production origin card object, for example. Here, if giving the opportunity of a pair card object production wins, instead of the screen under single card production 400, a screen under pair card production 500 as shown in FIG. 8(A) is displayed on the display 30.

In addition, although the lottery probability for drawing lots the opportunity of a pair card object production is set into the production origin card object and it is determined by the lottery whether the opportunity of a pair card object production is to be given in this embodiment, it does not need to be limited to this. For example, it may be determined at random whether the opportunity of a pair card object production is given.

Similar to the single card object, the pair card object to be produced is selected from one or more pair card objects in the unusable state by a lottery. For example, the probability of the lottery is set for each of a plurality of pair card objects. In addition, it is possible to know the pair card object in the unusable state by referring to the card information data acquired from the FIG. 40.

In addition, the pair card object to be produced may be determined (selected) at random without a lottery.

Therefore, the pair card object 502 under production corresponding to a pair card object that is drawn lots is displayed on the screen under pair card production 500 while being rotated. However, in this embodiment, in order to produce a pair card object, it is necessary to further use a FIG. 40 (hereinafter, called “latter figure”) different from the FIG. 40 (hereinafter, called “former figure”) that has been authenticated on the kind and whether having been registered based on the game information and the game machine ID at the time of the production start of the normal card object (single card object). That is, the latter FIG. 40 is pair to the former FIG. 40. Furthermore, in the pair card object to be produced, a game character corresponding to the latter FIG. 40 is pair to a game character corresponding to the former FIG. 40. However, in a virtual game of this embodiment, the latter FIG. 40 is another FIG. 40 that is not selected as the player character 152 and is a friend character 154 or a game character that can turn into the friend character 154.

In this embodiment, a hint about the latter FIG. 40 is displayed on the pair card object 502 under production drawn lots. As shown in FIG. 8(A), a silhouette of the image of the game character corresponding to the latter FIG. 40 is displayed on the pair card object 50 under production. Specifically, a silhouette of the game character corresponding to the FIG. 40b shown in FIG. 2(B) is displayed on the pair card object 502 under production. In addition, although it is unclear in the drawing, the game character corresponding to the former FIG. 40 is displayed with a color image in the pair card object 502 under production.

This is a mere example, and theme music (sound effects) that is played at the time that the game character corresponding to the latter FIG. 40 appears may be output from the speaker 34 as a hint. Otherwise, the game apparatus 10 may be vibrated by a vibration pattern that is set in advance to the game character corresponding to the latter FIG. 40. In such a case, a vibrator is to be incorporated in the game apparatus 10.

Furthermore, although a hint about the latter FIG. 40 is given in this embodiment, it does not need to be limited to this. The latter FIG. 40 may be notified directly by displaying the game character corresponding to the latter FIG. 40 with a color image in a pair card object under production. In such a case, the player can know the latter FIG. 40 easily.

Furthermore, if the screen under pair card production 500 is displayed on the display 30, the placement screen 200 as shown in FIG. 5(A) is displayed on the display 30 in parallel to this. However, in such a case, a message that the latter FIG. 40 should be placed is displayed in the placement screen 200.

Here, if the player places the FIG. 40 on the placement screen 200 (display surface of the display 30), the game apparatus 10 acquires the figure ID from this FIG. 40 (IC tag 50). If the FIG. 40 is of the kind used in the game application concerned and is a FIG. 40 (latter FIG. 40) about a game character that is paired with the game character corresponding to the former FIG. 40, the game apparatus 10 produces a pair card object drawn lots. That is, this pair card object is set usable.

Since the figure ID is thus acquired (read-in) from the latter FIG. 40, as described above, it may be said that an opportunity to read predetermined data from the latter FIG. 40 is given that the production opportunity of a pair card object is given.

Furthermore, the latter FIG. 40 is thus used when producing a pair card object, and in this embodiment, the latter FIG. 40 does not need to be registered into the game apparatus 10 that executes this game application. Therefore, the player can produce a pair card object by using a FIG. 40 that is owned by a friend etc., for example. However, the player may own the latter FIG. 40, and it may be registered into the game apparatus 10 that executes this game application.

In addition, in this embodiment, if the FIG. 40 that is placed later is not of the kind used in the game application concerned, production of a pair card object becomes failure, and returns to selection of a production origin. Then, instead of the screen under pair card production 500, the production origin card selection screen 350 is displayed on the display 30. In the following, this is the same about the case where production of a pair card object is failure.

Furthermore, when a pair card object is to be produced, production of a pair card object also becomes failure when a FIG. 40 is not placed on the placement screen 200 for the latter FIG. 40 within a predetermined time period (ten (10) seconds—few or several tens of seconds, for example).

Furthermore, when the FIG. 40 that is placed later is of the kind used in the game application concerned but different from the latter FIG. 40 corresponding to the game character displayed in the under production pair card object 502 in silhouette, production of a pair card object becomes failure. For example, in an example shown in FIG. 8(A), when the FIG. 40 having a different kind such as the FIG. 40c shown in FIG. 2(C) is placed, production of a pair card object becomes failure.

If succeeding in production of a pair card object, instead of the screen under pair card production 500, and a screen after pair card production 550 as shown in FIG. 8(B) is displayed on the display 30. The produced pair card object 552 is displayed on the screen after pair card production 550, and a display area 554 is provided above it.

Images of the player character 152 having a predetermined pose and the game character (here, friend character 154) that is paired to the player character 152 are displayed in the produced pair card object 552 as a pattern. Furthermore, contents of the effect activated by using the produced pair card object 552 are displayed with a text in the display area 554. Here, description that the offensive power of each of the player character 152 and the friend character 154 is increased 25 percent (%) is indicated (displayed).

Furthermore, if the pair card object 552 is produced, after the card information data is updated and the updated card information data is written in the FIG. 40, returns to the production origin card selection screen 350 shown in FIG. 6(B), and the production processing of a normal card object is continued. In addition, update of the card information data is as described above.

However, when the card information data is to be written, the updated card information data is written after the placement screen 200 as shown in FIG. 5(A) is displayed and it is confirmed whether the FIG. 40 that is placed on this placement screen 200 is the same as the former FIG. 40 that the card information data is acquired at the time of producing the normal card object. In addition, a method of confirmation on whether the FIG. 40 is the same is as described above.

Thus, the updated card information data is written into the former FIG. 40 that the card information data is acquired at the time of producing the normal card object. That is, when producing the pair card object, information that the pair card object concerned is usable is written into the FIG. 40 that is previously passed over the game apparatus 10 (placement screen 200).

In addition, the information that the produced pair card object can be used is also written in the card information data of the latter FIG. 40 (FIG. 40 passed over the game apparatus 10 later).

Furthermore, in this embodiment, when the latter FIG. 40 corresponding to the game character that is displayed in the pair card object concerned in silhouette is passed over the game apparatus 10 after the pair card object to be produced is drawn lots, the pair card object can be produced when satisfying a predetermined condition (having a predetermined relationship) such as a case where two game characters respectively corresponding to the two FIG. 40 are the same as two game characters being displayed in the pair card object concerned.

However, a method of production of the pair card object is only an example, and should not be limited. For example, a pair card object may be produced by the lottery or at random by passing over the latter FIG. 40 that is different in kind from the former FIG. 40 at the time that the player passes the former FIG. 40 over the game apparatus 10 and thus the screen under single card production 400 is being displayed.

Furthermore, if the icon 304 is selected in the card production menu screen 300 shown in FIG. 6(A), production processing of a special card object is executed(started).

As described above, a special card object makes further higher the effect that is activated at the time that the normal card object is used, and is produced (changed) from the normal card object. In this embodiment, a special card object is produced using two FIG. 40 used in the game application.

The figure IDs of the two FIG. 40 are sequentially read-in, and when the FIG. 40 that is placed previously on the placement screen 200 (hereinafter, called a “first FIG. 40” for convenience of explanation) and the FIG. 40 that is placed lately on the placement screen 200 (called a “second FIG. 40” for convenience of explanation) are of the same kind (kind information) but physically (individual information) differ from each other, a special card object can be produced.

If production processing of a special card object is executed, the placement screen 200 for placing the first FIG. 40 is displayed on the display 30. However, a message that the first FIG. 40 should be placed is displayed in the placement screen 200 for placing the first FIG. 40. In addition, the player can determine arbitrarily a turn of placing the two FIG. 40.

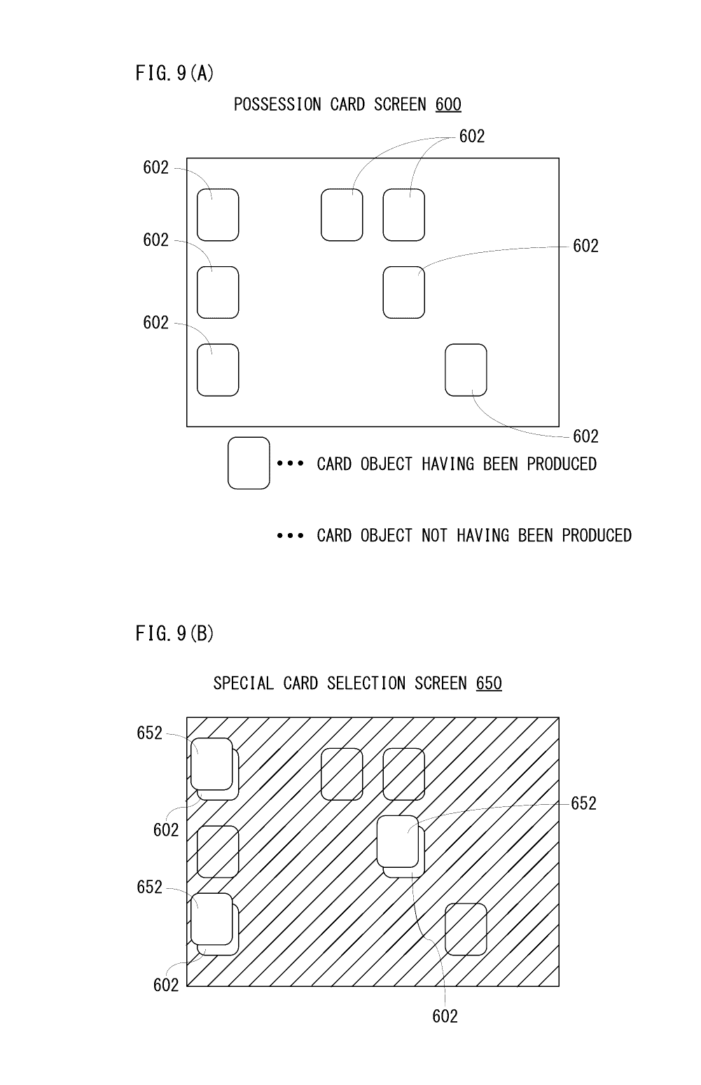

If the first FIG. 40 is placed on the placement screen 200, the figure ID of the first FIG. 40 is acquired, and it is authenticated whether the game information is correct, and when the game information is correct, the card information data (hereinafter called “first card information data”) is acquired from the first FIG. 40. Then, a possession card screen 600 as shown in FIG. 9(A) is displayed on the display 30.

One or more card objects 602 that are produced using the first FIG. 40 are displayed in the possession card screen 600. In addition, in FIG. 9(A) (the same in FIG. 9(B)), the card objects 602 are shown without patterns in the white color. Furthermore, only a silhouette is displayed about a card object having not produced yet.

However, about the card object 602 that has been already changed to the special card, decoration different from that of a normal card object is applied. In this embodiment, the special card object is provided with decoration more luxurious than that of the normal card object. As an example, in a special card, a background image is displayed, or a background is painted over with gold, while a background of a normal card object is solid color. This possession card screen 600 is displayed based on the card information data acquired from the first FIG. 40.

Subsequently, the placement screen 200 for placing the second FIG. 40 is displayed on the display 30. However, a message that the second FIG. 40 should be placed is displayed in the placement screen 200 for placing the second FIG. 40.

If the second FIG. 40 is placed on the placement screen 200, the figure ID of the second FIG. 40 is acquired, and it is authenticated whether the game information is correct. Furthermore, it is also authenticated whether the individual information of the second FIG. 40 differs from the individual information of the first FIG. 40. When the game information is correct and the individual information is different from the individual information of the first FIG. 40, the card information data (hereinafter “second card information data”) is acquired from the second FIG. 40.

However, if the second FIG. 40 is the same (completely the same) as the first FIG. 40, it is notified that the special card object cannot be produced, and returns to the main menu.

If the second card information data is acquired, it is determined (searched) whether there is any card object that is the same as the card object produced using the first FIG. 40 out of the card objects produced using the second FIG. 40.

Since a special card object cannot be produced when there is no the same card object, trying on another FIG. 40 in the same kind is proposed, and returns to the placement screen 200 for placing the second FIG. 40.

When there is the same card object, a special card selection screen 650 as shown in FIG. 9(B) is displayed on the display 30. On this special card selection screen 650, in the possession card screen 600 about the first FIG. 40, a card object 652 that is the same as the card object produced using the first FIG. 40 among the card objects produced using the second FIG. 40 is displayed in an overlapping manner (in front) on the card object 602. At this time, a portion except the card objects 602 and 652 being overlapped is grayed-out including a background. In addition, in FIG. 9(B), having been grayed-out is expressed by attaching slant lines. Therefore, only the card objects 602 and 652 being overlapped are displayed in a selectable manner.

If the player selects desired card objects 602 and 652 in the special card selection screen 650, the selected card objects 602 and 652 are changed to a special card object. That is, a special card object is produced. Although illustration is omitted, if a special card is produced, a screen after special card production that is similar to one of the screen after single card production 450 as shown in FIG. 7(B) and the screen after pair card production 550 as shown in FIG. 8(B) is displayed on the display 30.

In the screen after special card production, the special card object is displayed, and contents of the effect activated by using this special card object are displayed. However, the effect activated by using a special card object is the same as that of the normal card object having been changed to the special card object concerned, and the effect is higher than that of the normal card object concerned.

If a special card object is produced, the first placement screen 200 and the second placement screen 200 are sequentially displayed, and the updated first card information data is written in the first FIG. 40 and the updated second card information data is written in the second FIG. 40.

In addition, in this embodiment, when a special card object is produced, information of the special card object concerned is stored in both of the two FIG. 40 that are used for production of the special card object concerned, but not need to be limited to this. The information of the special object may be written in one of the FIG. 40. Otherwise, the information of the special object may be written into the FIG. 40 that is registered in the game apparatus 10 that it is used in the game application of this embodiment.

The number of times that the production processing of a special card object can be executed includes a predetermined limit, for example, once a day. Therefore, if the number of producible times is set in the game apparatus 10 and a special card object is produced, the number of producible times is decremented by one (1).

However, the number of producible times does not need to be limited to once a day, and may be two or more times a day. Furthermore, the number of producible times may be increased gradually as the game advances.

In addition, although the special card object is produced by selecting one from one or more the same normal card objects when the normal card objects respectively produced using the two FIG. 40 that are of the same kind but different from each other in this embodiment, it does not need to be limited to this. A special card object may be produced for all the same normal card objects, or the predetermined number of special card objects may be produced by selecting the predetermined number of two or more of the normal card objects.

Furthermore, when the normal card objects produced using respective FIG. 40 satisfy a predetermined condition (have a predetermined relationship) as such a case where the produced normal card objects using respective one of the two FIG. 40 that are of the same kind but different from each other are the same, a special card object is made producible, but not need to be limited to this. For example, even if the normal card object produced using one FIG. 40 and the normal card object produced using the other FIG. 40 are different from each other, a special card object may be produced when the effect that is activated is the same (predetermined rates differ).

Returning to FIG. 4(A), if the icon 106 is selected in the main menu screen 100, registering the FIG. 40 that is used in this game application into the game apparatus 10 is selected. If performance of processing that registers the FIG. 40 into the game apparatus 10 is selected, the placement screen 200 shown in FIG. 5(A) is displayed on the display 30. If the FIG. 40 is placed on the placement screen 200, the game apparatus 10 transmits the game machine ID via the non-contact communication module 22 and the antenna 24 together with the write instruction for this game machine ID. In response to this, in the FIG. 40, the game machine ID is stored (registered) in the EEPROM 54b as described above. However, prior to the game apparatus 10 transmits the write instruction of the game machine ID, the figure ID is read from the FIG. 40, and it is authenticated whether the FIG. 40 is the FIG. 40 used in this game application (whether the game information is correct).

Although each processing executed by the CPU12 shown in FIG. 1 will be described in the following, the CPU 12 executes each processing according to the game application (game program) of this embodiment.

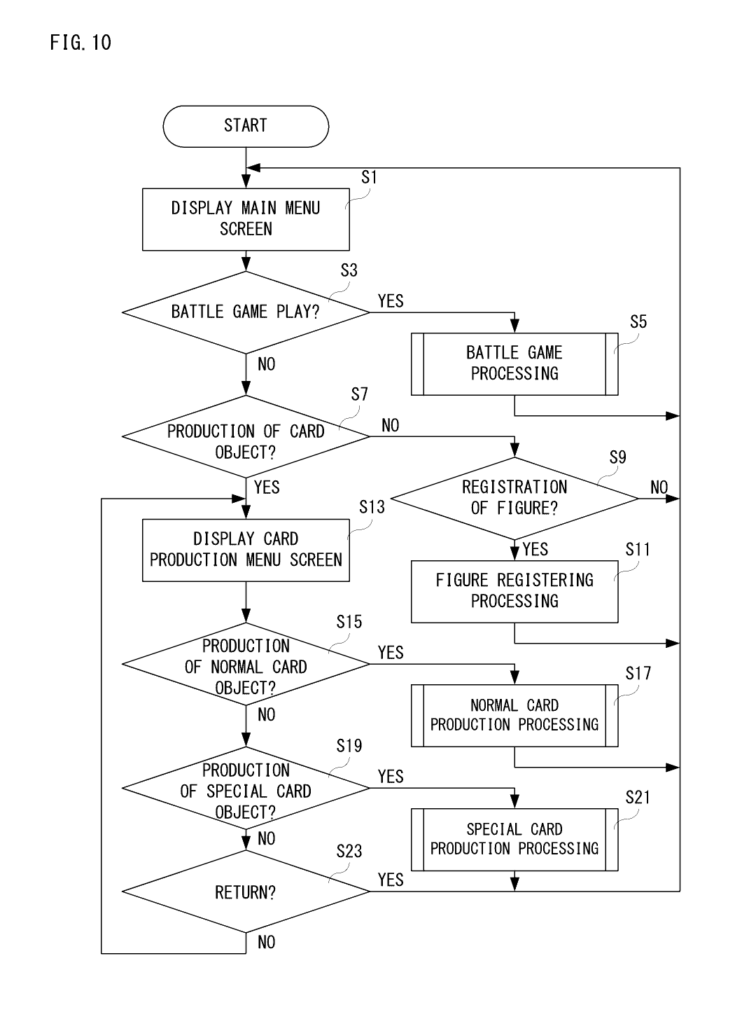

FIG. 10 is a flowchart showing entire processing of the game of this embodiment executed by the CPU 12 of FIG. 1. As shown in FIG. 10, if the entire processing is started, the CPU 12 displays, in a step S1, the main menu screen 100 as shown in FIG. 4(A) on the display 30.

In addition, although illustration is omitted, when the entire processing is started, prior to displaying the main menu screen 100, save data that stored in the flash memory 16 is read-in, and data of the number of producible times of the special card object is stored in the RAM 14. However, when the current date is newer than the date stored in the save data, the number of producible times is reset.

In a next step S3, it is determined whether the play of the battle game is selected. Here, the CPU 12 determines whether the icon 102 is selected (ON) in the main menu screen 100. More specifically, the CPU 12 detects operation input data, and determines whether the instruction to select the icon 102 is input. In the following, this is the same about a case where it is determined whether there is any instruction or selection using the input device 26. In addition, in parallel to the entire processing, the CPU 12 executes detection processing of the operation input and stores the operation input data that is input from the input device 26 in the RAM 14.

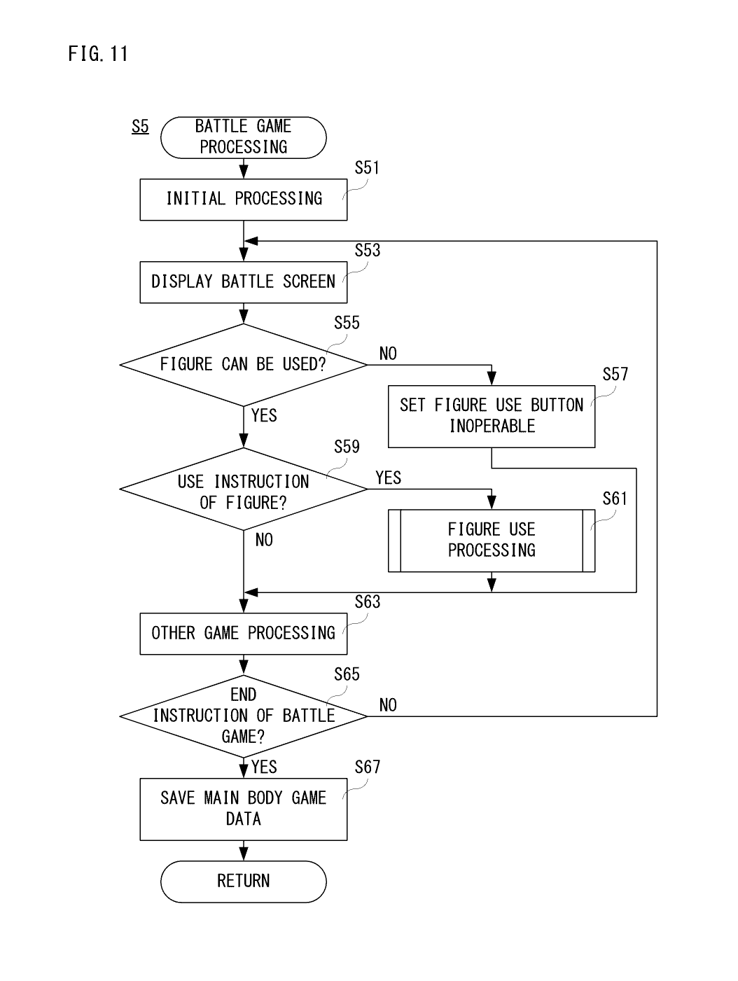

If “YES” is determined in the step S3, that is, if the play of a battle game is selected, the battle game processing (see FIG. 11) described later is executed in a step S5, and returns to the step S1. On the other hand, if “NO” is determined in the step S3, that is, if the play of the battle game is not selected, it is determined in a step S7 whether producing a card object is selected. Here, the CPU 12 determines whether the icon 104 is selected in the main menu screen 100.

If “NO” is determined in the step S7, that is, if producing a card object is not selected, it is determined in a step S9 whether it is registration of a figure. Here, the CPU12 determines whether the icon 106 is selected in the main menu screen 100. If “NO” is determined in the step S9, that is, if all the icons 102-106 are not selected, the process returns to the step S1 as it is. On the other hand, if “YES” is determined in the step S9, that is, if the icon 106 is selected, registration processing of a figure is executed in a step S11, and returns to the step S1. Since the registration processing of a figure is as having described above, a duplicate description is omitted.

On the other hand, if “YES” is determined in the step S7, that is, if producing a card object is selected, the card production menu screen 300 as shown in FIG. 4(B) is displayed on the display 30 in a step S13.

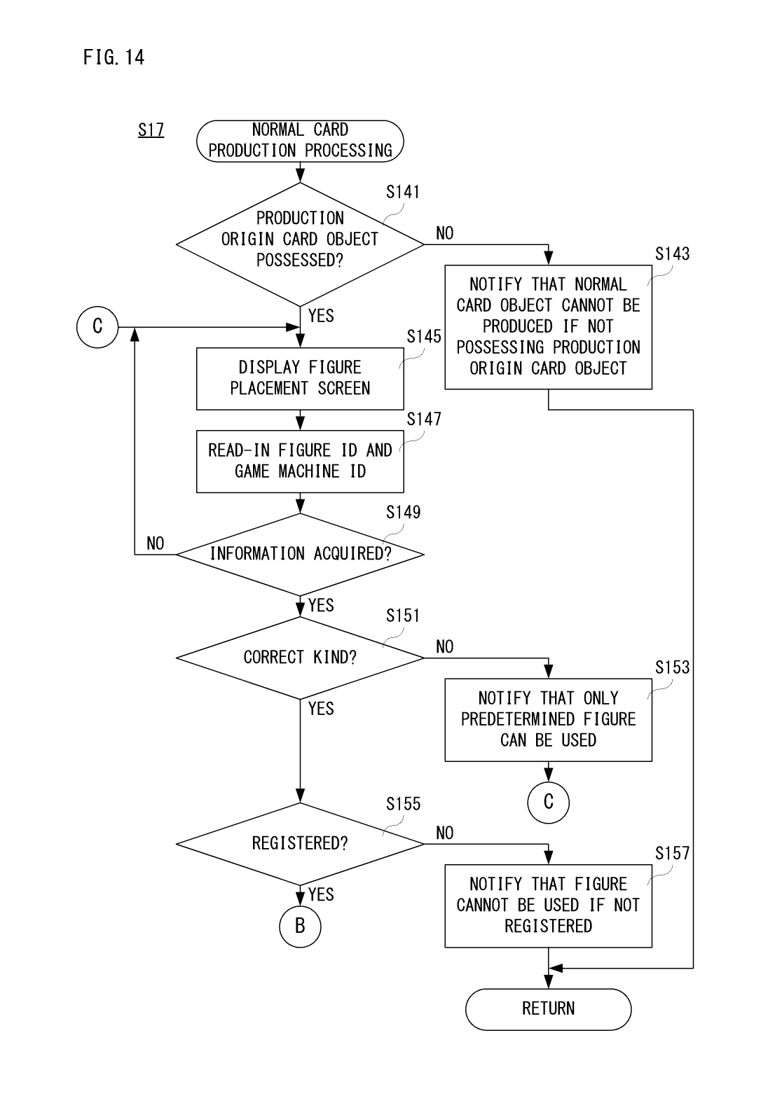

In a next step S15, it is determined whether it is production of a normal card object. Here, the CPU 12 determines whether the icon 310 is selected in a state where the icon 302 is selected in the card production menu screen 300. If “YES” is determined in the step S15, that is, if it is production of a normal card object, after executing normal card production processing (see FIG. 14-FIG. 16) described later in a step S17, returns to the step S1.

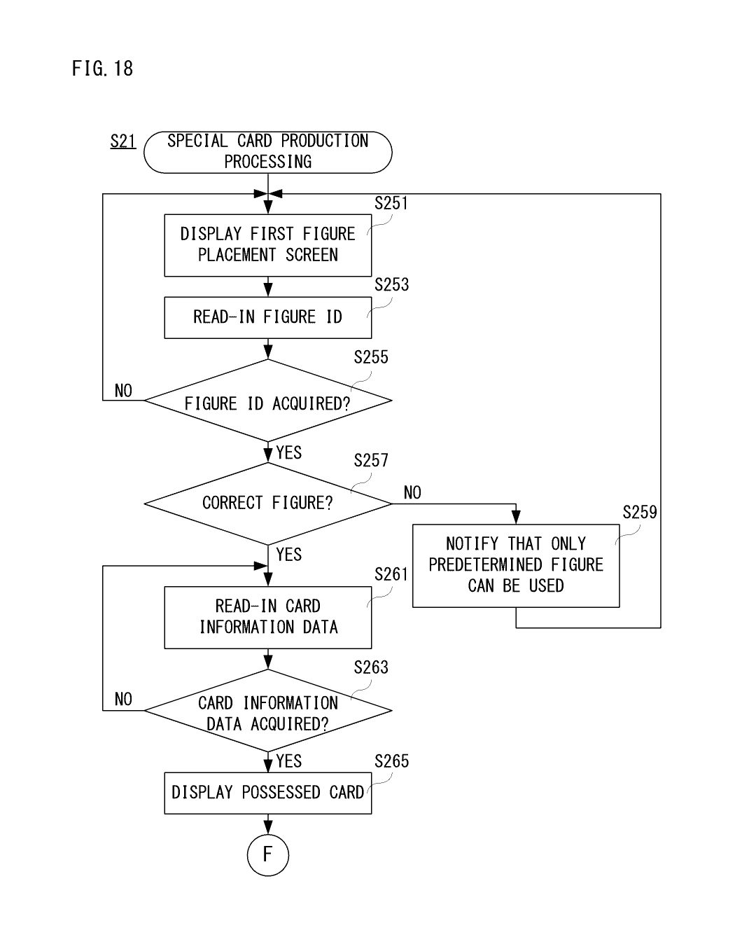

On the other hand, if “NO” is determined in the step S15, that is, if it is not production of a normal card object, it is determined in a step S19 whether it is production of a special card object. Here, the CPU 12 determines whether the icon 310 is selected in a state where the icon 304 is selected in the card production menu screen 300. If “YES” is determined in the step S19, that is, if it is production of a special card object, after executing special card production processing (see FIG. 18-FIG. 21) described later in a step S21, returns to the step S1.

On the other hand, if “NO” is determined in the step S19, that is, if it is not production of a special card object, it is determined in a step S23 whether the process returns to the main menu. Here, the CPU 12 determines whether the icon 312 is selected in the card production menu screen 300. If “YES” is determined in the step S23, that is, if returning to the main menu, the process returns to the step S1. If “NO” is determined in the step S23, that is, if not returning to the main menu, the process returns to the step S13.

FIG. 11 is a flowchart about battle game processing of the step S5 shown in FIG. 10. As shown in FIG. 11, if the battle game processing is started, the CPU 12 executes initial processing in a step S51. The initial processing is processing that constructs a virtual game space and arranges respective characters and objects appearing in the game space in initial positions, and sets initial values of various parameters used in the battle game processing.

In a subsequent step S53, the battle screen 150 as shown in FIG. 4(B) is displayed on the display 30. In a next step S55, it is determined whether the FIG. 40 is usable. If “NO” is determined in the step S55, that is, if use of the figure is impossible, a figure use button is set so as to be inoperable in a step S57, and advances to a step 63. For example, in the step S57, in the operation screen displayed in relation to the battle screen 150, the icon for using the FIG. 40 displayed in the screen concerned is grayed-out, whereby the icon is set impossible to select. In the step S57, the icon for using the FIG. 40 may be non-displayed. In addition, the icon for using the FIG. 40 is set inoperable if the FIG. 40 is used at the predetermined number of times (1 time, for example) in the battle game.

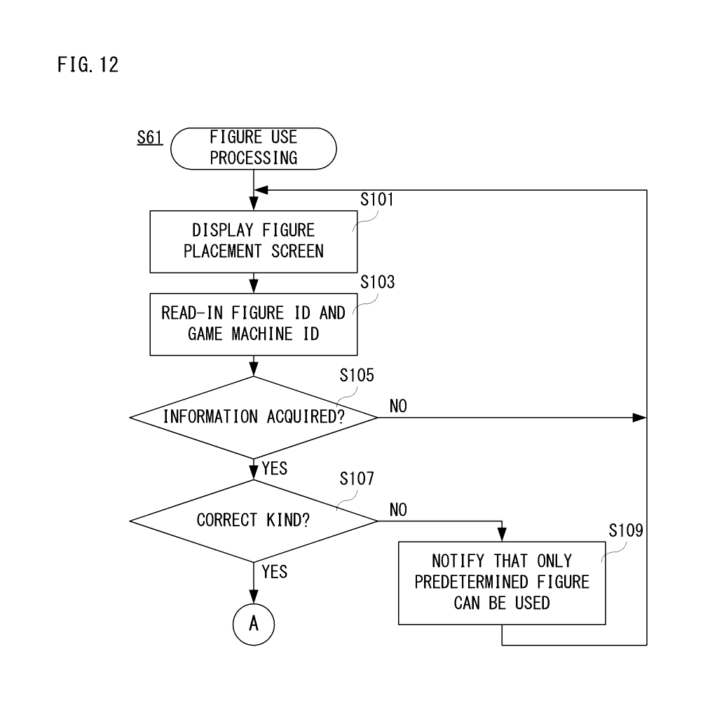

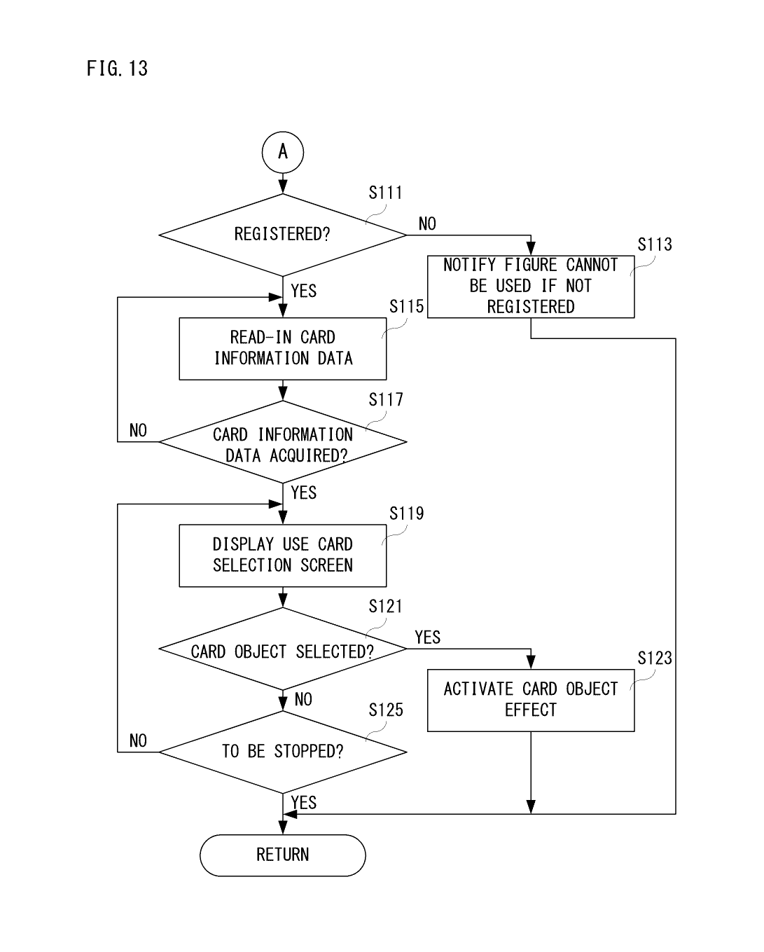

On the other hand, if “YES” is determined in the step S55, that is, if use of the FIG. 40 is possible, it is determined in a step S59 whether there are any instructions to use the FIG. 40. Here, the CPU 12 determines whether the icon for using the FIG. 40 is selected. If “NO” is determined in the step S59, that is, if there is no instruction to use the FIG. 40, the process advances to a step S63 as it is. On the other hand, if “YES” is determined in the step S59, that is, if there is an instruction to use the FIG. 40, figure use processing (see FIG. 12 and FIG. 13) described later is executed in a step S61, and advances to the step S63.

In the step S63, other game processing will be executed. For example, the CPU 12 makes the player character 152 or the friend character 154 attack the enemy character 160 according to an operation by the player. Furthermore, according to an operation by the CPU 12 (computer), the enemy character 160 attacks the player character 152 or the friend character 154.

In a subsequent step S65, it is determined whether the end of the battle game is instructed by the player. If “NO” is determined in the step S65, that is, if the end of the battle game is not instructed, the process returns to the step S53. On the other hand, if “YES” is determined in the step S65, that is, if the end of the battle game is instructed, main body game data is saved into the flash memory 16 in a step S67, and returns to the entire processing. The main body game data includes the production origin card data and the data of the number of producible times, for example.

FIG. 12 and FIG. 13 are flowcharts showing the figure use processing of the step S61 shown in FIG. 11.

As shown in FIG. 12, if the figure use processing is started, the CPU 12 displays the figure placement screen 200 as shown in FIG. 5(A) on the display 30 in a step S101. In a next step S103, the figure ID and the game machine ID are read-in. The CPU 12 tries acquisition of the data of the figure ID and the game machine ID that are stored in the EEPROM 54b of the IC tag 50 incorporated in the FIG. 40 by transmitting the read instruction of the figure ID and the game machine ID via the non-contact communication module 22 and the antenna 24.

In a subsequent step S105, it is determined whether the information is acquired. Since there is a case where the game machine ID is not stored, the CPU 12 determines here whether at least the figure ID is acquired. If “NO” is determined in the step S105, that is, if no information (figure ID and game machine ID) is acquired, the process returns to the step S101. On the other hand, if “YES” is determined in the step S105, that is, if the information is acquired, it is determined in a step S107 whether the information is of a correct kind. Here, the CPU 12 determines whether the game information included in the acquired figure ID indicates the game application concerned.

If “NO” is determined in the step S107, that is, if it is not of a correct kind, it is notified in a step S109 that figures other than a predetermined figure (FIGS. 40a, 40b and 40c in this embodiment) cannot be used, and returns to the step S101. On the other hand if “YES” is determined in the step S107, that is, if it is of the correct kind, as shown in FIG. 13, it is determined in a step S111 whether the FIG. 40 concerned is registered. Here, the CPU 12 determines whether the acquired game machine ID corresponds to the game machine ID of the own machine (the game apparatus 10 concerned). In addition, when the game machine ID cannot be acquired from the FIG. 40, the CPU 12 determines that the FIG. 40 concerned is not registered.

If “NO” is determined in the step S111, that is, if the FIG. 40 concerned is not registered, it is notified in at step S113 that the FIG. 40 cannot be used if not registered, and returns to the battle game processing. Although it has been made to return to the battle game processing in this embodiment, the battle game processing may be suspended or terminated so as to shift to figure registration processing. Therefore, even if it is a FIG. 40 of the correct kind, when the FIG. 40 not registered is used, in the battle game, a card object cannot be used. Even if the player who does not own the FIG. 40 borrows and uses the FIG. 40 that other players own, for example, since the FIG. 40 concerned is not registered into the game apparatus 10 that is executing this game application, it is impossible to activate an effect using a card object. However, a FIG. 40 not registered into the game apparatus 10 may be used. In this case, a game machine ID is not read in the step S103, but processing of the steps S111 and S113 is omitted.

On the other hand, if “YES” is determined in the step S111, that is, if the FIG. 40 concerned is registered, the card information data is read-in from the FIG. 40 concerned in a step S115. The CPU 12 tries acquisition of the card information data that is stored in the EEPROM 54b of the IC tag 50 incorporated in the FIG. 40 by transmitting the read instruction of the card information data via the non-contact communication module 22 and the antenna 24.

In a subsequent step S117, it is determined whether the card information data is acquired. If “NO” is determined in the step S117, that is, if the card information data is not acquired, the process returns to the step S115. On the other hand, if “YES” is determined in the step S117, that is, if the card information data is acquired, the use card selection screen 250 as shown in FIG. 5(B) is displayed on the display 30 in a step S119. Image data of this use card selection screen 250 is produced using the acquired card information data. In the following, this is the same about a case where the card information data is acquired.

In addition, although premised on the card information data being correct in this embodiment, when the acquired data is data (data other than card information data) used in other game applications, the card information data cannot be used. In such a case, it is notified that the acquired data cannot be used and it is necessary to make the FIG. 40 concerned usable in the game application concerned by initializing the card information data. When the player initializes the card information data that is stored in the FIG. 40 (EEPROM 54b) according to this, the FIG. 40 that stores the card information data concerned becomes usable after that.

In a next step S121, it is determined whether the card object (252a, 252b, 252c) is selected in the use card selection screen 250. If “YES” is determined in the step S121, that is, if the card object is selected, the effect according to the selected card object is activated in a step S123, and returns to the battle game processing. Therefore, the ability value of the player character 152 is changed (increased), for example.

On the other hand, if “NO” is determined in the step S121, that is, if the card object is not selected, it is determined in a step S125 whether the selection of the card object is to be stopped. Here, the CPU 12 determines whether the icon 260 is selected in the use card selection screen 250. If “NO” is determined in the step S125, that is, if not stopping the selection of a card object, the process returns to the step S119. On the other hand, if “YES” is determined in the step S125, that is, if the selection of a card object is to be stopped, the process returns to the battle game processing as it is. In addition, when returning to the battle game processing, the use card selection screen 250 is closed (non-displayed).

Thus, the player who owns the FIG. 40 can raise the ability value of the player character 152 and can advance the game relatively easily by using the card object that is indicated by the card information data that is stored in the FIG. 40 concerned if the FIG. 40 concerned is registered into the game apparatus 10 that executes the game application. Therefore, it is possible to can say that using the FIG. 40 in the battle game, that is, using the card object assists advance of the game processing.

Furthermore, although illustration is omitted, when the player character 152 does not possess one card object either, without displaying the use card selection screen 250 after acquiring the card information data, it is notified that the player character 152 does not acquire the card object, and the figure use processing is terminated.

FIG. 14-FIG. 16 are flowcharts about normal card production processing in the step S17 shown in FIG. 10. Although details of the normal card production processing will be described in the following, the same or similar processing as or to the already explained processing is described simply.

As shown in FIG. 14, if the normal card production processing is started, the CPU 12 determines in a step S141 whether the player character 152 possesses the production origin card object.

If “NO” is determined in the step S141, that is, if the player character 152 does not possess the production origin card object, it is notified in a step S143 that a normal card object cannot be produced unless possessing the production origin card object, and returns to the entire processing after terminating the card production processing.

On the other hand, if “YES” is determined in the step S141, that is, if the player character 152 possesses the production origin card object, the placement screen 200 as shown in FIG. 5(A) is displayed on the display 30 in a step S145.

In a next step S 147, the figure ID and the game machine ID are read-in, and it is determined in a step S149 whether information is acquired. If “NO” is determined in the step S149, the process returns to the step S145. On the other hand, if “YES” is determined in the step S149, it is determined in a step S151 whether it is of the correct kind.

If “NO” is determined in the step S151, it is notified in a step S153 that only the predetermined FIG. 40 can be used, and returns to the step S145. On the other hand, if “YES” is determined in the step S151, it is determine in a step S155 whether the FIG. 40 concerned is registered. If “NO” is determined in the step S155, it is notified in a step S157 the FIG. 40 cannot be used if not registered, and returns to the entire processing.

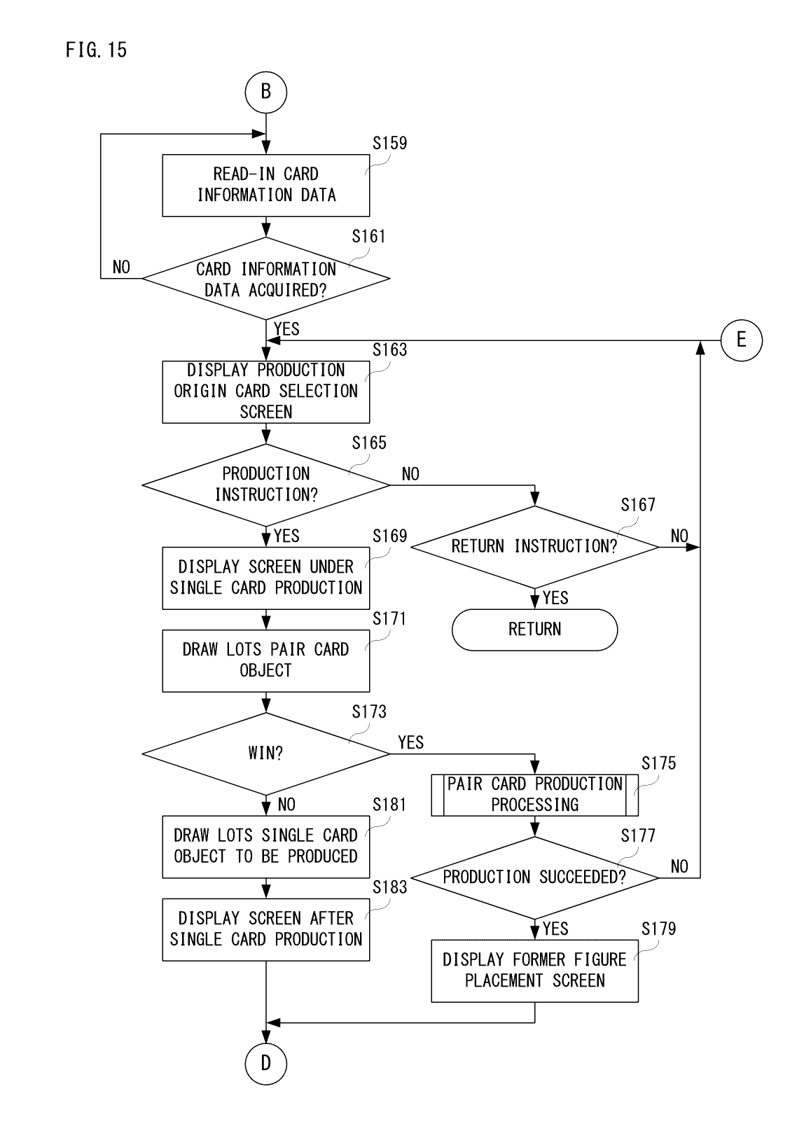

On the other hand, if “YES” is determined in the step S155, as shown in FIG. 15, the card information data is read-in in a step S159, and it is determined in a step S161 whether the card information data is acquired. If “NO” is determined in the step S161, the process returns to the step S159. On the other hand, if “YES” is determined in the step S161, the production origin card selection screen 350 as shown in FIG. 6(B) is displayed on the display 30 in a step S163. In a subsequent step S165, it is determined whether there are any production instructions.

If “NO” is determined in the step S165, that is, if there is no production instruction, it is determined in a step S167 whether there are any return instructions. If “NO” is determined in the step S167, that is, if there is no return instruction, the process returns to the step S163. On the other hand, if “YES” is determined in the step S167, that is, if there is the return instruction, the process returns to the entire processing. On the other hand, if “YES” is determined in the step S165, that is, if there is a production instruction, the screen under single card production 400 shown in FIG. 7(A) is displayed on the display 30 in a step S169.

Subsequently, in a step S171, the CPU 12 draws lots whether the production opportunity of the pair card object is to be given. Here, it is drawn lots whether the production opportunity of the pair card object is to be given according to the lottery probability that is set in the production origin card object. In a next step S173, it is determined whether giving the production opportunity of the pair card object wins. That is, the CPU 12 determines whether it is decided to give the production opportunity of the pair card object.

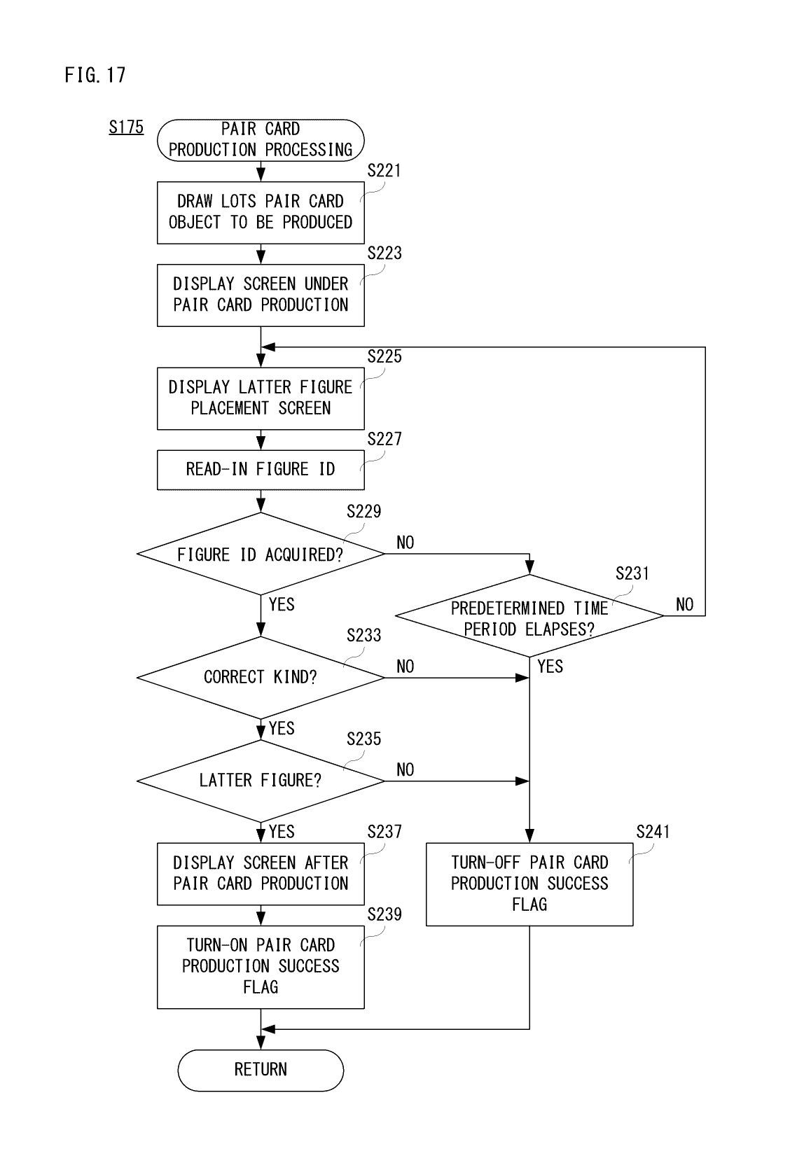

If “YES” is determined in the step S173, that is, if giving the production opportunity of the pair card object wins, pair card production processing (see FIG. 17) described later is executed in a step S175, and it is determined in a step S177 whether the production of the pair card object is success. Here, the CPU 12 determines whether a pair card production success flag that is stored in the RAM 14 is ON.

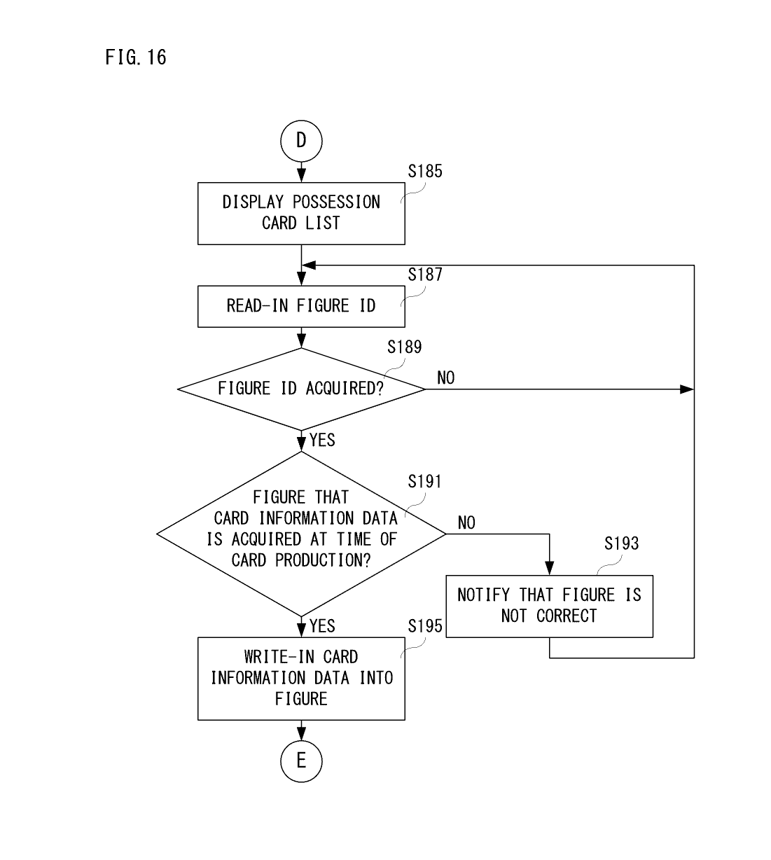

If “NO” is determined in the step S177, that is, if production of the pair card object is failure, the process returns to the step S163. On the other hand, if “YES” is determined in the step S177, that is, if the production of the pair card object is success, the placement screen 200 for the former FIG. 40 is displayed on the display 30 in a step S179, and advances to a step S185 shown in FIG. 16. That is, in the step S179, the placement screen 200 for placing the FIG. 40 that the card information data is acquired is displayed on the display 30 in the normal card production processing (steps S159 and S161).

Furthermore, if “NO” is determined in the step S173, that is, if giving the production opportunity of the pair card object does not win, the single card object to be produced is drawn lots in a step S181. In addition, one single card object is selected from one or more single card objects that are producible (currently set unusable) in this embodiment. The card information data is updated at this time. That is, the information corresponding to the produced single card object is set usable. Then, the screen after single card production 450 as shown in FIG. 7(B) is displayed on the display 30 in a step S183, and advances to the step S185. In addition, in the step S183, the screen after single card production 450 for the single card object that is selected in the step S181 is displayed.

As shown in FIG. 16, a possession card list is displayed in the step S185. In addition, the possession card list is the same as the possession card screen 600 shown in FIG. 9(A). Subsequently, the figure ID is read-in in a step S187, and it is determined in a step S189 whether the figure ID is acquired. If “NO” is determined in the step S189, the process returns to the step S187. On the other hand, if “YES” is determined in the step S189, it is determined in a step S191 whether it is the FIG. 40 that the card information data is acquired at the time of normal card production. Here, the CPU 12 determines whether the individual information included in the figure ID corresponds to the individual information of the FIG. 40 that the card information data is acquired at the time of card production. However, when producing the pair card, it is determined whether it is the former FIG. 40 that the card information data is acquired at the time of the normal card production.

If “NO” is determined in the step S191, that is, if it is not the FIG. 40 that the card information data is acquired at the time of the normal card production, it is notified that the FIG. 40 is not correct in a step S193, and returns to the step S187. On the other hand, if “YES” is determined in the step S191, that is, if it is the FIG. 40 that the card information data is acquired at the time of the normal card production, the updated card information data is written in the FIG. 40 in a step S195, and returns to the step S163 shown in FIG. 15.

FIG. 17 is a flowchart of pair card production processing in the step S175 shown in FIG. 15. Although details of the pair card production processing will be described in the following, the same or similar processing as or to the already explained processing is described simply.

As shown in FIG. 17, if the pair card production processing is started, the CPU 12 draws lots a pair card object to be produced in a step S221. In a subsequent step S223, instead of the screen under single card production 400, the screen under pair card production 500 as shown in FIG. 8(A) is displayed on the display 30.

The placement screen 200 for the latter FIG. 40 is displayed on the display 30 in a subsequent step S225. The figure ID is read-in in a next step S227, and it is determined in a step S229 whether the figure ID is acquired. If “NO” is determined in the step S229, it is determined in a step S231 whether a predetermined time period (10 seconds—few or several tens of seconds, for example) elapses after starting the pair card production processing.

In addition, although illustration is omitted, a timer is provided and a count is started when the pair card production processing is started. In the step S231, the CPU 12 determines whether a count value of this timer exceeds the predetermined time period.

If “NO” is determined in the step S231, that is, if the predetermined time period does not elapse after starting the pair card production processing, the process returns to the step S225. On the other hand, if “YES” is determined in the step S231, that is, if the figure ID is not acquired even if the predetermined time period elapses after starting the pair card production processing, it is determined that the latter FIG. 40 is not placed on the placement screen 200 and thus the pair card object production is failure, and in a step S241, a pair card production success flag is turned OFF, and returns to the normal card production processing.

Furthermore, if “YES” is determined in the step S229, it is determined in a step S233 whether it is of the correct kind. If “NO” is determined in the step S233, it is determined that pair card object production is failure, and advances to the step S241. In addition, if “NO” is determined in the step S233, after notifying that only the predetermined FIG. 40 can be used, the process may be advanced to the step S231 or step S241.

On the other hand, if “YES” is determined in the step S233, it is determined in a step S235 whether it is the latter FIG. 40 that is pair to the former FIG. 40. Here, the CPU 12 determines whether the kind information included in the acquired figure ID is the same as the kind information of the FIG. 40 corresponding to the game character that is displayed in the pair card object in silhouette.

If “NO” is determined in the step S235, that is, if it is not the latter FIG. 40, it is determined that the pair card production is failure, and advances to the step S241. On the other hand, if “YES” is determined in the step S235, that is, if it is the latter FIG. 40, the screen after pair card production 550 as shown in FIG. 8(B) is displayed on the display 30 in a step S237. At this time, the information corresponding to the produced pair card object 552 is set usable, and the card information data is updated. Therefore, in the produced pair card object 552, the image of the game character corresponding to the latter FIG. 40 is also changed from a silhouette to a color image. Then, the pair card production success flag is turned ON in a step S239, and returns to the normal card production processing.

FIG. 18-FIG. 21 show special card production processing in the step S21 shown in FIG. 10. Although details of the special card production processing will be described in the following, the same or similar processing as or to the already explained processing is described simply.

As shown in FIG. 18, if the special card production processing is started, the CPU 12 displays the placement screen 200 for the first FIG. 40 on the display 30. The figure ID is read-in in a next step S253, and it is determined in a step S255 whether the figure ID is acquired. If “NO” is determined in the step S255, the process returns to the step S251. On the other hand, if “YES” is determined in the step S255, it is determined in a step S257 whether it is of the correct kind.

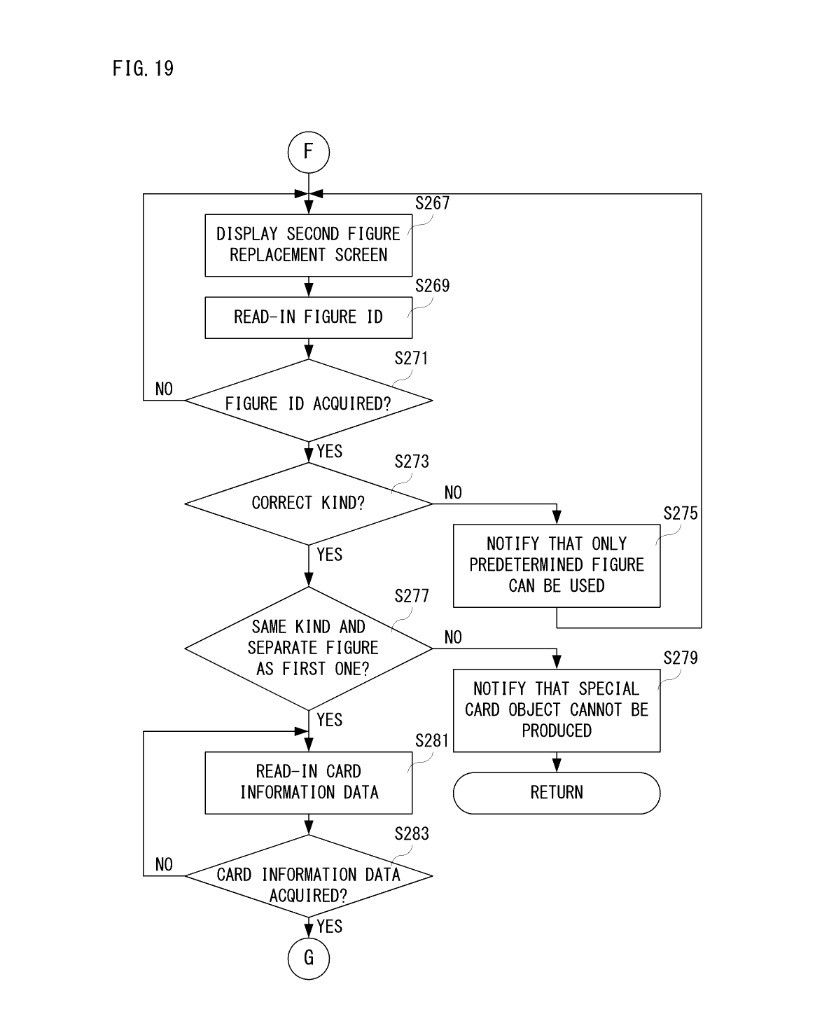

If “NO” is determined in the step S257, it is notified that only the predetermined FIG. 40 can be used in a step S259, and returns to the step S251. On the other hand, if “YES” is determined in the step S257, the card information data is read-in in a step S261, and it is determined in a step S263 whether the card information data is acquired. If “NO” is determined in the step S263, the process returns to the step S261. On the other hand, if “YES” is determined in the step S263, the possession card screen 600 as shown in FIG. 9(A) is displayed on the display 30 in a step S265, and advances to a step S267 shown in FIG. 19.

As shown in FIG. 19, the placement screen 200 for the second FIG. 40 is displayed on the display 30 in the step S267. The figure ID is read-in in a next step S269, and it is determined in a step S271 whether the figure ID is acquired. If “NO” is determined in the step S271, the process returns to the step S267. On the other hand, if “YES” is determined in the step S271, it is determined in a step S273 whether it is of the correct kind.

If “NO” is determined in the step S273, it is notified that only the predetermined FIG. 40 can be used in a step S275, and returns to the step S267. On the other hand, if “YES” is determined in the step S273, it is determined in a step S277 whether the second FIG. 40 is of the same kind as the first FIG. 40 and separate (differ physically) FIG. 40 from the first FIG. 40. Here, the CPU 12 determines the kind information out of the information included in figure ID that is acquired from the second FIG. 40 is the same as the first kind information and the individual information differs from the first individual information.

If “NO” is determined in the step S277, that is, if the second FIG. 40 is completely the same as the first FIG. 40, it is notified in a step S279 that the special card object cannot be produced, and returns to the entire processing. However, in a case where “NO” is determined in the step S277, it may be notified that the same kind of a separate FIG. 40 is to be placed, and then, the process returns to the step S267.

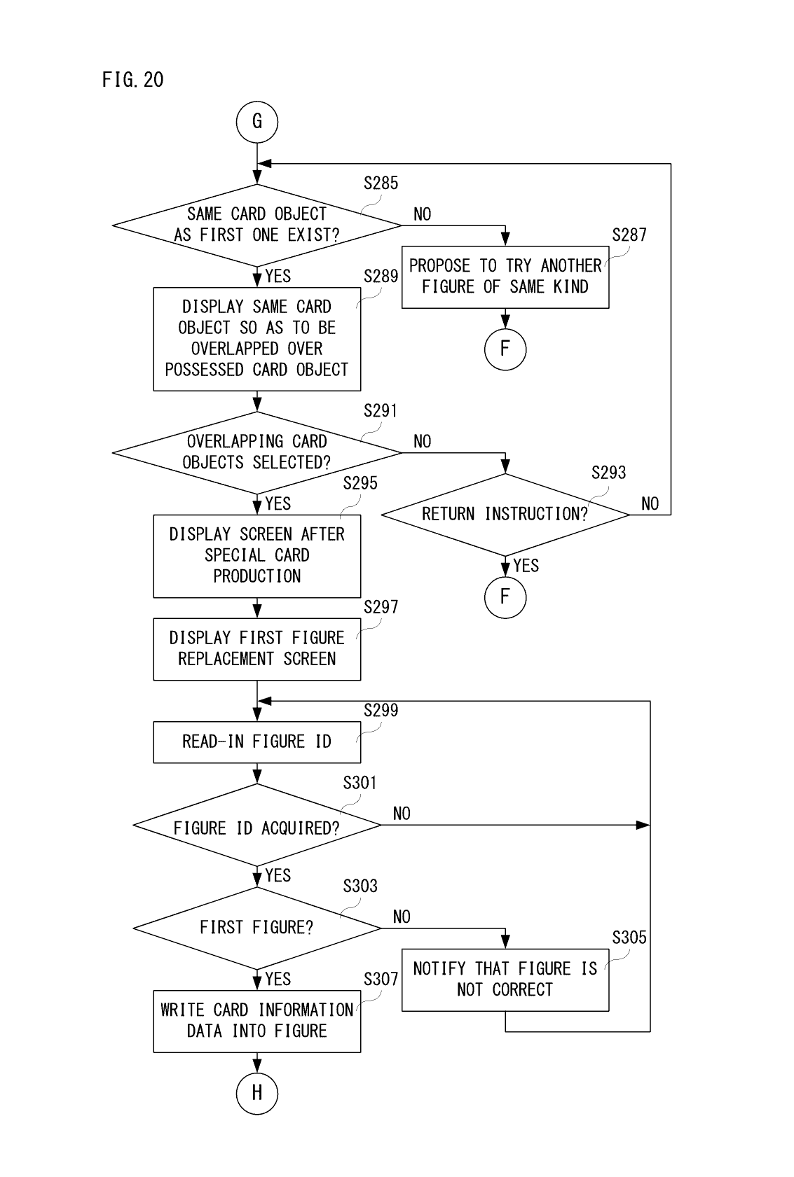

On the other hand, if “YES” is determined in the step S277, that is, if the second FIG. 40 is the same kind as the first FIG. 40 and a separate FIG. 40, the card information data is read-in in a step S281, and it is determined in a step S283 whether the card information data is acquired. If “NO” is determined in the step S283, the process returns to the step S281. On the other hand, if “YES” is determined in the step S283, it is determined, in a step S285 shown in FIG. 20, whether there is any same card object as the first one. Here, the CPU 12 determines whether there is any same card object as the card object indicated that it is usable in the card information data acquired from the second FIG. 40 out of the card objects indicated that they are usable in the card information data acquired from the first FIG. 40.

If “NO” is determined in the step S285, that is, if there is no same card object as the first one, it is proposed to try on the same kind of another FIG. 40, and returns to the step S267. On the other hand, if “YES” is determined in the step S285, that is, if there is the same card object as the first one, the same card object is displayed so as to be overlapped on the possessed card object in a step S289. That is, the special card selection screen 650 as shown in FIG. 9(B) is displayed on the display 30.

Subsequently, in a step S291, it is determined whether the overlapping card objects are selected. That is, the CPU 12 determines whether the normal card objects (602, 652) that are changed to the special card are selected. If “NO” is determined in the step S291, that is, if the overlapping card objects are not selected, it is determined in a step S293 whether it is the return instruction. If “NO” is determined in the step S293, the process returns to the step S285. On the other hand, if “YES” is determined in the step S293, the process returns to the step S267 shown in FIG. 19, and redoes from the placing of the second FIG. 40.

On the other hand, if “YES” is determined in the step S291, that is, if there is selection of the overlapping card objects, the special card object is produced, and in a step S295, the screen after special card production is displayed on the display 30 about the selected card objects. If the special card object is produced, in each of the first card information data and the second card information data, the information indicating that the corresponding normal card object is changed to the special card object is added, and accordingly, the first and the second card information data are updated, respectively.

The placement screen 200 for the first FIG. 40 is displayed on the display 30 in a subsequent step S297. The figure ID is read-in in a next step S299, and it is determined in a step S301 whether the figure ID is acquired. If “NO” is determined in the step S301, the process returns to step S299. On the other hand, if “YES” is determined in the step S301, it is determined in a step S303 whether it is the first FIG. 40.

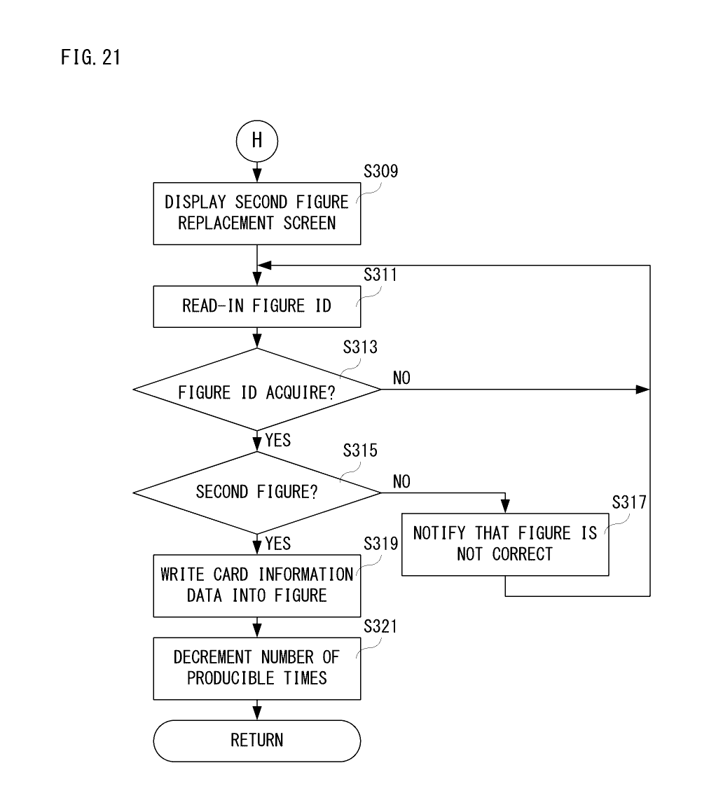

If “NO” is determined in the step S303, it is notified in a step S305 that it is different from the first FIG. 40, and returns to the step S299. On the other hand, if “YES” is determined in the step S303, the first card information data is written in the first FIG. 40 in a step S307, and advances to a step S309 shown in FIG. 21.

As shown in FIG. 21, the placement screen 200 for the second FIG. 40 is displayed on the display 30 in the step S309. The figure ID is read-in in a next step S311, and it is determined in a step S313 whether the figure ID is acquired. If “NO” is determined in the step S313, the process returns to the step S311. On the other hand, if “YES” is determined in the step S313, it is determined in a step S315 whether it is the second FIG. 40.

If “NO” is determined in the step S315, it is notified in a step S317 that it is different from the second FIG. 40, and returns to the step S311. On the other hand, if “YES” is determined in the step S315, the second card information data is written in the second FIG. 40 in a step S319, and in a step S321, the number of producible times is decremented by one (1), and returns to the entire processing.

According to this embodiment, since the card object is produced using the two figures, it is possible to increase the pleasure to produce the object and the pleasure to increase the number of the objects. Furthermore, the sense of accomplishment by making the number of the objects increase can be obtained. Therefore, it is possible to improve amusement of the information processing using the figure(s).

Furthermore, according to this embodiment, since the card object is produced using the production origin card object that is obtained in the battle game etc., if the battle game is advanced, it is possible to increase an opportunity to produce and use the card object, and thus increase the pleasure to advance the battle game.

In addition, although an item such as a card object is produced in this embodiment, a kind of item does not need to be limited. Furthermore, instead of production of the item, a predetermined game event may be generated. For example, a new stage may be made playable, or a new character may be made to appear in the virtual game.

Furthermore, although the figure is stored with the information on whether each card object is usable as card information data in this embodiment, the data of the card object that is usable (produced) may be stored.

Furthermore, although the pair card object is produced using the two figures that the kind information are different from each other and the game information are the same in this embodiment, a pair card object may be produced using two figures that both of the kind information and the game information are different from each other, respectively.

Furthermore, although the special card object is produced using the two figures that the kind information are the same and the individual information are different from each other in this embodiment, a special card object may be produced using two figures that the kind information are also different from each other. In such a case, for example, when the possession card screen is displayed, when there are card objects being displayed on the same position, the card objects concerned may be made to change to a special card.

Furthermore, although the IC tag is made to be incorporated in a predetermined figure in this embodiment, the IC tag may be incorporated in a predetermined card (IC card). In such a case, the game apparatus performs non-contact communication processing with the IC card but not with the figure.

Furthermore, although an item such as a card object is produced using the production origin card object that is obtained in the battle game while the game application is executed in this embodiment, should not be limited to this. Also when an application other than game application is executed, by obtaining a virtual object that becomes an origin or source of an item that is provided in the application concerned, the virtual object may be changed to a certain item by using a figure. However, in fact, an item that is prepared in advance is changed from an unusable state to a usable state rather than the virtual object is changed to a certain item.

Furthermore, although an item such as a card object is produced using the production origin card object in this embodiment, should not be limited to this. For example, a certain item may be produced by performing a non-contact communication with two figures without using a production origin card object, and a certain object may be produced when a predetermined condition that data read from the two figures correspond to each other, or the like is satisfied.

Furthermore, although the special card object is set so as to have the activated effect larger than that of the normal card object in this embodiment, may be set so as to have the activated affect smaller than that of the normal card object partly or as a whole.

Furthermore, although a game apparatus is mentioned as an example of an information processing apparatus in this embodiment, as far as it has a function to perform a non-contact wireless communication with the IC tag that is incorporated in the figure, the embodiment can be applied to computers such as general-purpose PCs (personal computer), tablet PCs, workstations, feature phones, smartphones, etc.

Furthermore, although the CPU that is incorporated in the game apparatus is made to execute all the processing in this embodiment, it does not need to be limited to this. A system may be constructed such that a whole or part of the processing is executed by other apparatuses such as a server that is provided so as to be communicable with the game apparatus, and a plurality of apparatuses execute the processing jointly.

It should be noted that the specific numerical values described in the above-described embodiments are only examples, and to be set appropriately in accordance with the actual products.

Although certain example systems, methods, storage media, devices and apparatuses have been described herein, it is to be understood that the appended claims are not to be limited to the systems, methods, storage media, devices and apparatuses disclosed, but on the contrary, are intended to cover various modifications and equivalent arrangements included within the spirit and scope of the appended claims.

What is claimed is:

1. An information processing apparatus, comprising:
a communication module configured to perform a non-contact communication with each of a first storage medium and a second storage medium;
a reading module configured to read first data from the first storage medium and read second data from the second storage medium while using the communication module;
an object producing module configured to produce a first object by using the first data and the second data that are read by the reading module; and
a writing module configured to write the first object that is produced by the object producing module in at least one of the first storage medium and the second storage medium while using the communication module.

2. The information processing apparatus according to claim 1, wherein the object producing module is configured to further produce a second object that differs from the first object by using the first data or the second data.

3. The information processing apparatus according to claim 2, wherein the first object and the second object are different in ability from each other.

4. The information processing apparatus according to claim 1, further comprising a decision module configured to decide, when the first data is read from the first storage medium or the second data is read from the second storage medium by the reading module, by a predetermined method whether the second data can be succeedingly read from the second storage medium or the first data can be succeedingly read from the first storage medium, wherein
the reading module is configured to read the second data from the second storage medium or the first data from the first storage medium when it is decided by the decision module that it is possible to read the second data from the second storage medium or the first data from the first storage medium,.

5. The information processing apparatus according to claim 4, further comprising a notifying module configured to notify the second storage medium or the first storage medium that is reading candidate when it is decided by the decision module that the second data can be read from the second storage medium or the first data can be read from the first storage medium.

6. The information processing apparatus according to claim 1, further comprising a first determination module configured to determine whether the first data read from the first storage medium and the second data read from the second storage medium satisfy a predetermined condition, wherein
the object producing module is configured to produce the first object by using the first data and the second data when it is determined by the first determination module that the predetermined condition is satisfied.

7. The information processing apparatus according to claim 1, further comprising a second determination module configured to determine whether the first object or the second object stored in the first storage medium and the first object or the second object stored in the second storage medium satisfy a predetermined condition, wherein
the object producing module is configured to produce a third object combining the first objects with each other or a fourth object combining the second objects with each other when it is determined that the first object or the second object stored in the first storage medium and the first object or the second object stored in the second storage medium satisfy the predetermined condition.

8. The information processing apparatus according to claim 7, wherein the second determination module is executable within a predetermined restriction.

9. The information processing apparatus according to claim 1, further comprising an execution module configured to execute an application, wherein
the first object and the second object can be used in a predetermined scene of the application.

10. An information processing system, comprising:
a communication module configured to perform a non-contact communication with each of a first storage medium and a second storage medium;
a reading module configured to read first data from the first storage medium and read second data from the second storage medium while using the communication module;
an object producing module configured to produce an object by using the first data and the second data that are read by the reading module; and
a writing module configured to write the object that is produced by the object producing module in at least one of the first storage medium and the second storage medium while using the communication module.

11. A non-transitory storage medium storing an information processing program executable by a computer comprising a communication module configured to perform a non-contact communication with each of a first memory and a second memory, wherein the information processing program causes the computer to function as:
a reading module configured to read first data from the first memory and read second data from the second memory while using the communication module;
an object producing module configured to produce an object using the first data and the second data that are read by the reading module; and
a writing module configured to write the object that is produced by the object producing module in at least one of the first memory and the second memory while using the communication module.

12. An information processing method that is executed by a computer comprising a communication module configured to perform a non-contact communication with each of a first storage medium and a second storage medium, wherein the information processing method comprising steps of:
(a) reading first data from the first storage medium and read second data from the second storage medium while using the communication module;
(b) producing an object using the first data and the second data that are read in the step (a); and
(c) writing the object that is produced in the step (b) in at least one of the first storage medium and the second storage medium while using the communication module.
